(19) United States
(12) Patent Application Publication
(10) Pub. No.: US 2026/0046926 A1
(43) Pub. Date: Feb. 12, 2026

(54) METHODS, ARCHITECTURES, APPARATUSES AND SYSTEMS FOR WIDEBAND OPERATION FOR SIDELINK IN UNLICENSED BANDS

(71) Applicant: InterDigital Patent Holdings, Inc., Wilmington, DE (US)

(72) Inventors: Tuong Hoang, Montreal (CA); Tao Deng, New York, NY (US); Martino Freda, Laval (CA); Aata El Hamss, Laval (CA); Patrick Tooher, Montreal (CA); Faris Alfarhan, Montreal (CA); Moon-il Lee, Melville, NY (US)

(21) Appl. No.: 19/101,408

(22) PCT Filed: Aug. 1, 2023
(86) PCT No.: PCT/US2023/029196

§ 371 Date: Feb. 5, 2025

Related U.S. Application Data
(60) Provisional application No. 63/395,627, filed on Aug. 5, 2022.
(60) Provisional application No. 63/445,551, filed on Feb. 14, 2023.
(60) Provisional application No. 63/468,619, filed on May 24, 2023.

(51) Int. Cl. H04W 74/0808; H04W 72/25

(52) U.S. Cl. CPC H04W 74/0808; H04W 72/25

(57) ABSTRACT

The disclosure pertains to methods, architectures, apparatuses and systems for wideband operation for sidelink communications in unlicensed bands. In an embodiment, a method may be implemented in a wireless transmit/receive unit (WTRU). The method may include receiving scheduling information from a network for at least one sidelink transmission. The scheduling information may indicate a plurality of contiguous resource block (RB) sets. The method may include performing listen before talk (LBT) in the plurality of contiguous RB sets and, responsive to successful LBT in the plurality of contiguous RB sets, transmitting the at least one sidelink transmission in the plurality of contiguous RB sets. The at least one sidelink transmission may include sidelink control information indicating the plurality of contiguous RB sets used to transmit the at least one sidelink transmission.

### CROSS-REFERENCE TO RELATED APPLICATIONS

This application claims the benefit of U.S. Patent Application Nos. 63/395,627 filed Aug. 5, 2022, 63/445,551 filed Feb. 14, 2023, and 63/468,619 filed May 24, 2023, each of which is incorporated herein by reference in its entirety.

### TECHNICAL FIELD

This disclosure pertains to wireless communications. For example, one or more embodiments disclosed herein are related to methods, architectures apparatuses and systems for wideband operation for sidelink communications in unlicensed bands.

### BACKGROUND

In unlicensed bands, channel access procedures prior to transmitting allow a fair sharing of the unlicensed spectrum between different radio access technologies. Embodiments described herein have been designed with the foregoing in mind.

### BRIEF SUMMARY

Methods, architectures, apparatuses, and systems directed to wideband operation for sidelink communications in unlicensed bands are described herein. In an embodiment, a method implemented in a wireless transmit/receive unit (WTRU) is described herein. The method may include receiving scheduling information from a network for one or more sidelink transmissions. The scheduling information may indicate a set of scheduled resources. The method may include performing listen before talk (LBT) in the set of scheduled resources for acquiring a subset of resources of the set of scheduled resources. The method may include transmitting sidelink control information indicating the subset of acquired resources. The method may include transmitting data in the subset of acquired resources. The method may include transmitting feedback information to the network related to the one or more sidelink transmissions based on (e.g., a ratio between) a number of acquired resources and a number of scheduled resources.

In an embodiment, a WTRU including a processor and a transmitter and a receiver (e.g., a transceiver) operatively coupled to the processor is described herein. The WTRU may be configured to receive scheduling information from a network for one or more sidelink transmissions. The scheduling information may indicate a set of scheduled resources. The WTRU may be configured to perform LBT in the set of scheduled resources for acquiring a subset of resources of the set of scheduled resources. The WTRU may be configured to transmit sidelink control information indicating the subset of acquired resources. The WTRU may be configured to transmit data in the subset of acquired resources. The WTRU may be configured to transmit feedback information to the network related to the one or more sidelink transmissions based on (e.g., a ratio between) a number of acquired resources and a number of scheduled resources.

### BRIEF DESCRIPTION OF THE DRAWINGS

A more detailed understanding may be had from the detailed description below, given by way of example in conjunction with the drawings appended hereto. Figures in such drawings, like the detailed description, are exemplary. As such, the Figures and the detailed description are not to be considered limiting, and other equally effective examples are possible and likely. Furthermore, like reference numerals (“ref.”) in the Figures (“FIGs.”) indicate like elements, and wherein:

FIG. 1A is a system diagram illustrating an example communications system;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2 is a diagram illustrating an example resource pool for SL U;

FIG. 3 is a diagram illustrating several LBT or transmission schemes for SL U for one transport block (TB);

FIG. 4 is a diagram illustrating several LBT or transmission schemes for SL U for multiple TBs;

FIG. 5 is a resource diagram illustrating selection of resources for LBT or transmission schemes;

FIG. 6 is a resource diagram illustrating selection of resources for performing contiguous LBT;

FIG. 7 is a resource diagram illustrating selection of resources for performing LBT using puncturing/rate matching of another WTRU's channel occupancy time (COT);

FIG. 8 is a resource diagram illustrating a WTRU stopping transmissions in one slot before the reserved COT of another WTRU to assist the other WTRU in acquiring the channel;

FIG. 9 is a resource diagram illustrating a WTRU deferring transmission to a future slot as a function of LBT success;

FIG. 10 is a diagram illustrating selection of a set of slots available for LBT and transmission;

FIG. 11 is a diagram illustrating determination of whether a reserved resource is available or unavailable for LBT and transmission;

FIG. 12 is a diagram illustrating a WTRU procedure after it fails to perform LBT and transmission in one slot;

FIG. 13 is a diagram illustrating determination of available slots for wideband transmission;

FIG. 14 is a diagram illustrating determination of a channel access priority class (CAPC) to use based on the maximum (e.g., pre-) configured amount data to access the channel;

FIG. 15 is a resource diagram illustrating different transmission schemes and guard-band usages for wideband operation;

FIG. 16 is a diagram illustrating an example method for reselecting a LBT sub-band to use for wideband sidelink transmissions in unlicensed spectrum;

FIG. 17 is a diagram illustrating an example method for wideband sidelink transmissions in unlicensed spectrum;

FIG. 18 is a diagram illustrating an example method for selecting resources for performing LBT to use for wideband sidelink transmissions in unlicensed spectrum;

FIG. 19 is a diagram illustrating an example method for reporting feedback information to the network related to SL transmissions;

FIG. 20 is a diagram illustrating an example method for determining whether to keep a current LBT sub-band or to select another LBT sub-band;

FIG. 21 is a diagram illustrating an example method for determining a primary LBT sub-band;

FIG. 22 is a diagram illustrating an example method for selecting a slot in a resource selection window; and

FIG. 23 is a diagram illustrating an example method for transmission in a first starting symbol of a slot with multiple starting symbols.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components, and circuits have not been described in detail, so as not to obscure the following description. Further, embodiments and examples not specifically described herein may be practiced in lieu of, or in combination with, the embodiments and other examples described, disclosed, or otherwise provided explicitly, implicitly and/or inherently (collectively “provided”) herein.

Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

### Example Communication Systems

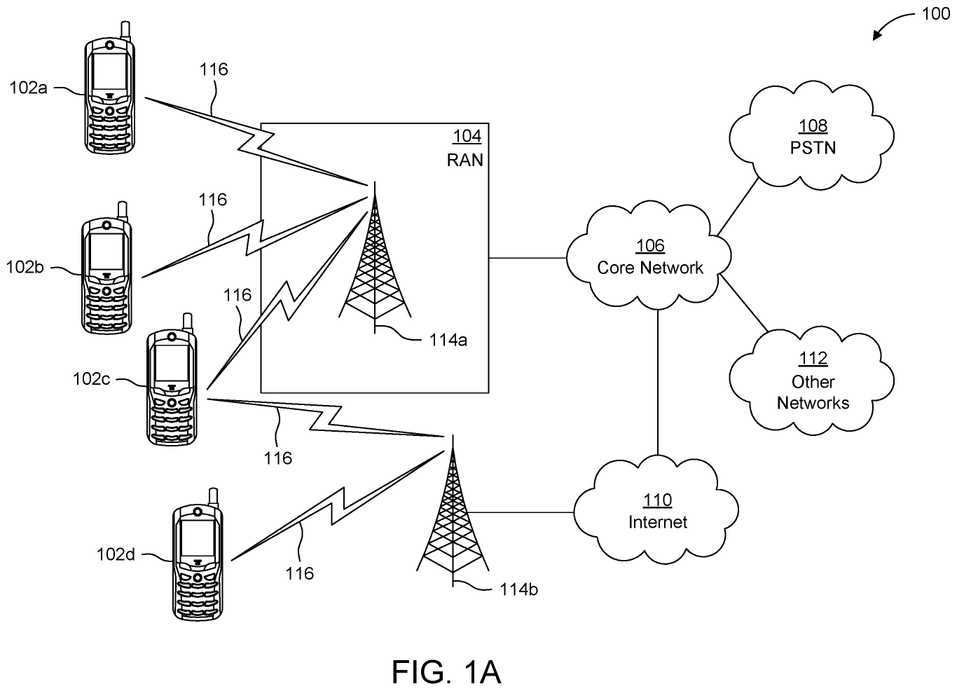

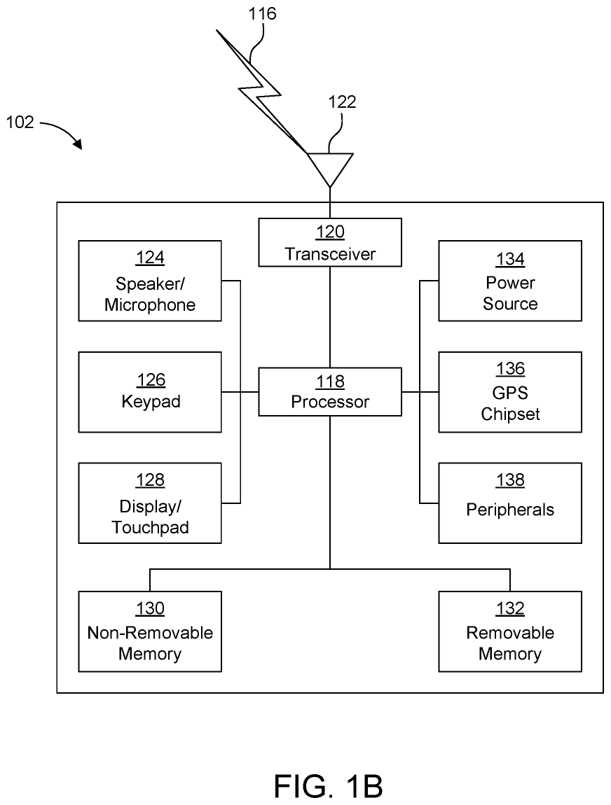

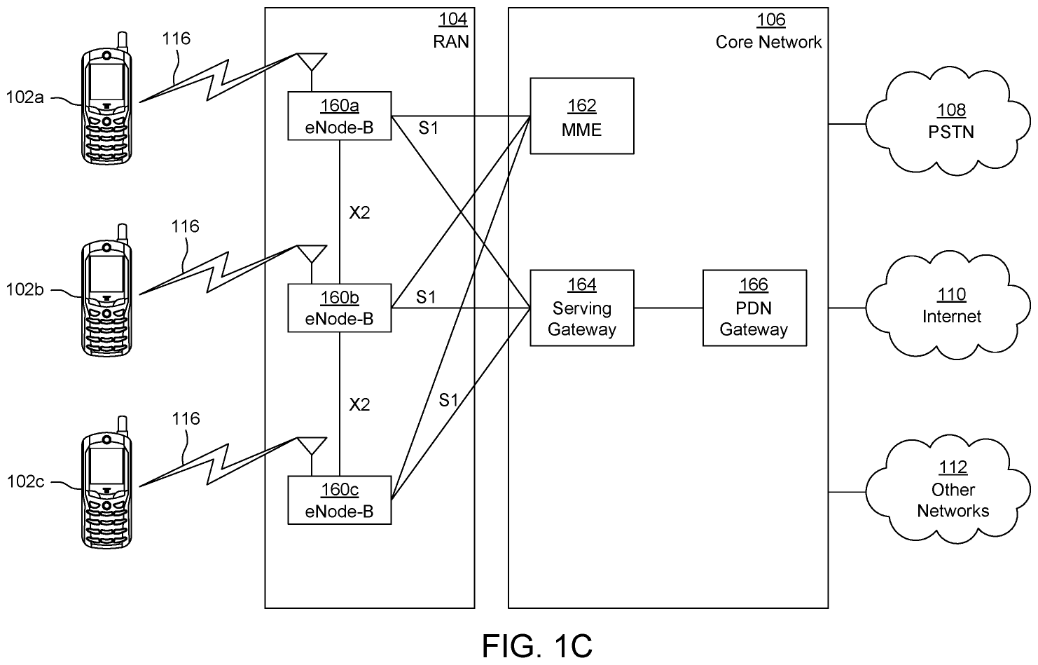

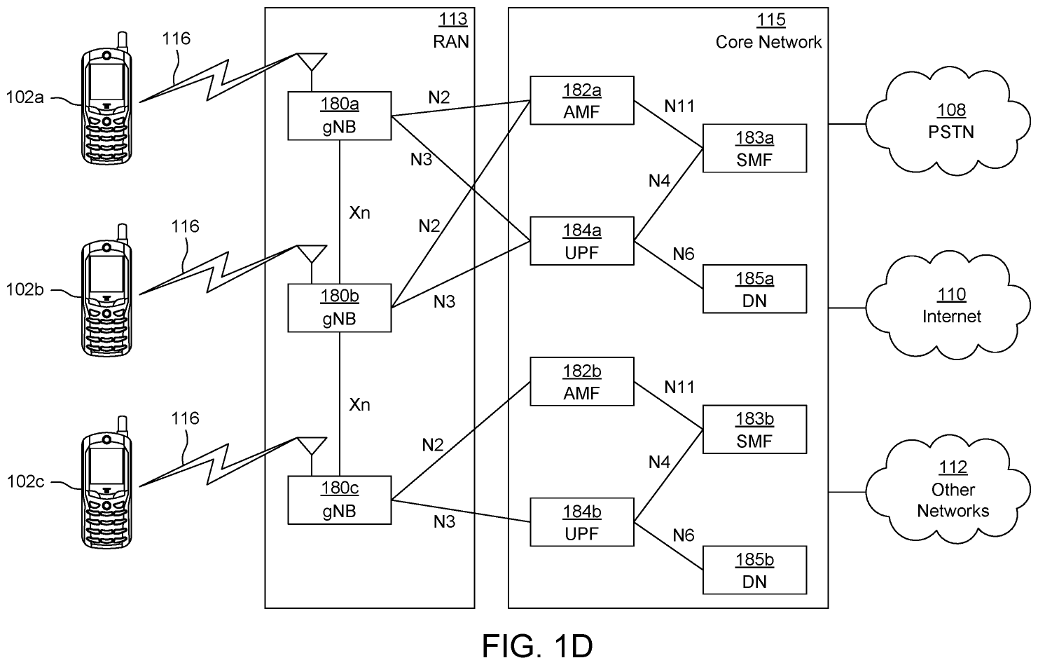

The methods, apparatuses and systems provided herein are well-suited for communications involving both wired and wireless networks. Wired networks are well-known. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VOIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network. In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHZ, and/or 80 MHZ, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHZ, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHZ, 4 MHZ, 8 MHZ, 16 MHZ, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 180b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 1026, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the uplink (UL) and/or downlink (DL), support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of Non-Access Stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF a82a, 182b may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may perform testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Throughout embodiments described herein the terms “serving base station”, “base station”, “gNB”, “network” collectively “the network” may be used interchangeably to designate any network element such as e.g., a network element acting as a serving base station. Embodiments described herein are not limited to gNBs and are applicable to any other type of serving base stations.

For the sake of clarity, satisfying, failing to satisfy a condition and configuring condition parameter(s) are described throughout embodiments described herein as relative to a threshold (e.g., greater or lower than) a (e.g., threshold) value, configuring the (e.g., threshold) value, etc. For example, satisfying a condition may be described as being above a (e.g., threshold) value, and failing to satisfy a condition (e.g., performance criteria) may be described as being below a (e.g., threshold) value. Embodiments described herein are not limited to threshold-based conditions. Any kind of other condition and parameter(s) (such as e.g., belonging or not belonging to a range of values) may be applicable to embodiments described herein.

Throughout embodiments described herein, (e.g., configuration) information may be described as received by a WTRU from the network, for example, through system information or via any kind of protocol message. Although not explicitly mentioned throughout embodiments described herein, the same (e.g., configuration) information may be pre-configured in the WTRU (e.g., via any kind of pre-configuration methods such as e.g., via factory settings), such that this (e.g., configuration) information may be used by the WTRU without being received from the network.

Throughout embodiments described herein, the expression “the WTRU may be configured with a set of parameters” is equivalent or may be used interchangeably with “the WTRU may receive configuration information (e.g., from another network element (e.g., gNB)) indicating a set of parameters”. Throughout embodiments described herein, the expressions “the WTRU may report something”, and “the WTRU may be configured to report something”, is equivalent or may be used interchangeably with “the WTRU may transmit (e.g., reporting) information indicating something”

In embodiments described herein the term Uu is used to refer to any of data, transmission, interface, characteristic etc., associated with the (up/down) link to the base station.

### Operation in Unlicensed Spectrum

Operation in unlicensed spectrum is described herein.

### SL Operation in Unlicensed Spectrum

It was agreed upon at the third-generation partnership project (3GPP) RAN #94 meeting that R18 sidelink (SL) evolution work item (WI) includes a study of support of sidelink operation for both mode 1 and mode 2 in unlicensed spectrum in frequency range 1 (FRI) (sidelink unlicensed). The unlicensed SL frequency bands are 5 GHz and 6 GHz and the Uu operation related to mode 1 is limited to licensed spectrum only. The sidelink unlicensed (SL U) channel access design may be based on regional regulation requirements with the existing 5G New Radio Unlicensed (NR U) channel access as a starting point.

R16 SL resource allocation mechanism specified for the licensed spectrum may be re-used. The scope of R18 SL U also covers changes to NR SL physical (PHY) channel structures and procedures to operate in unlicensed spectrum. For example, hybrid automatic repeat request (HARQ) feedback supported in new radio vehicle-to-everything (NR V2X) for unicast and groupcast transmissions will be evaluated in R18 WI discussions.

### Unlicensed Requirements for Single LBT Sub-Band

In unlicensed bands, channel access procedures prior to transmitting may allow a fair sharing of the unlicensed spectrum between different radio access technologies. Channel access may use a listen-before-talk (LBT) procedure. The listen-before-talk (LBT) procedure may be referred to as a mechanism by which an equipment may apply a clear channel assessment (CCA) check before using the channel. The CCA may utilize at least energy detection to determine the presence or absence of other signals on a channel to determine if a channel is occupied or clear, respectively. For some LBT types (e.g., type 2 LBT), fixed sensing duration of 16 or 25 us may be used to clear the channel. For other LBT types (e.g., type 1 LBT), a random number, which may be referred to as N, of sensing slots (e.g., each sensing slot spanning 9 us) of clear idle slots may be used to clear the channel. For example, the WTRU may perform transmission if the channel is idle for the duration required for (e.g., associated with) each sensing type.

There may be four channel access types (which may be referred to herein as LBT types) defined by the regulation, such as e.g., type 1 channel access, type 2A channel access, type 2B channel access, and type 2C channel access.

In the type 1 channel access, the transmitter may transmit after sensing the channel to be idle during N sensing slots, where N may be a (e.g., randomly chosen) number. Sensing may be performed for an additional defer duration each time the channel is sensed to be busy in one of the N slots.

In the type 2A channel access, the transmitter may transmit a transmission (e.g., immediately) after sensing the channel to be idle for at least 25 micro-seconds.

In the type 2B channel access, the transmitter may transmit a transmission (e.g., immediately) after sensing the channel to be idle for at least 16 micro-seconds.

In the type 2C channel access, the transmitter may not sense the channel before the transmission.

After a transmitter may have acquired the channel, the transmitter may occupy (e.g., perform transmission in) the channel during a channel occupancy time (COT). A COT may have an upper bound (e.g., maximum) duration depending on which LBT type may be used to acquire the channel. A transmitter may initiate a COT and may share it with another transmitter under some restrictions (e.g., conditions), e.g., LBT type 1 may be used to initially acquire the channel, and the gap between different transmission may be less than a (e.g., specified) gap.

### Wideband Operation in Unlicensed Uu:

In unlicensed spectrum, an example of bandwidth for one LBT sub-band may be 20 MHz. Wideband operation in unlicensed spectrum may be used to refer to the operation of a network element having bandwidth larger than 20 MHz (e.g., multiple LBT sub-bands). Wideband operation may enable the WTRU to obtain larger bandwidth and achieve higher throughput.

R16 NR Uu supports two types of gNB channel access for wideband operation, which may be referred to as type A and type B wideband channel access. In type A, the gNB may maintain an individual LBT process for each LBT sub-band, and may perform transmission in each LBT sub-band, if LBT is successful. Type A may be divided into two sub-types, which may be referred to as type A1 and type A2. In type A1, the backoff counter N may be initiated per LBT sub-band. In type A2, a single backoff counter N may be used for all LBT sub-bands. In type B, the gNB may select one LBT sub-band (e.g., cj) for type-1 LBT and the remaining LBT sub-bands for type-2 LBT (e.g., 2B) (e.g., sensing T_{mc}=25 us before Tx in LBT sub-band cj). The gNB may transmit in LBT sub-band cj and in any sub-band, ci, for which type-2 LBT may have been successful (e.g., channel found to be clear). Type B may be divided into type B1 and B2. In type B1, a single contention window (CWₚ) may be maintained for all LBT sub-bands, and, in type B2, an individual contention window (CWₚ) may be maintained for each LBT sub-band.

For UL operation, a WTRU may be scheduled with wideband physical uplink shared channel (PUSCH), and the WTRU may perform a PUSCH transmission if LBT is successful in all scheduled LBT sub-bands. Such a restriction may allow the network to avoid blind detection of the transmission from the WTRU due to an unpredictable LBT result.

To mitigate intra-carrier interference among transmissions in different LBT sub-bands between Wi-Fi and NR U, a guard-band between two contiguous LBT sub-bands may be introduced, which may be semi-statically configured or predefined (e.g., in 3GPP TS 38.101). If zero guard-band is configured, the gNB cannot perform transmission if it fails to acquire any LBT sub-band in the carrier. A guard-band between two LBT sub-bands may be used if the WTRU acquires two contiguous LBT sub-bands.

### NR V2X Mode 1 Scheduling:

For mode 1 dynamic scheduling, the network may schedule the WTRU for one or more sidelink grants for transmission of one TB. The network may indicate (e.g., transmit information indicating) the UL resource to be used to feedback the usage status of the grant. For example, if the WTRU uses the grant to transmit a HARQ-enabled TB, the WTRU may report acknowledge (ACK) and/or negative acknowledge (NACK) based on the ACK/NACK feedback or discontinuous transmission (DTX) from the Rx WTRU. If the WTRU uses the grant to transmit a HARQ-disabled TB, the WTRU may report NACK if more resources are expected to transmit the TB. Otherwise, the WTRU may report ACK.

In sidelink resource allocation, there may be two scheduling modes, which may be referred to herein as WTRU autonomous resource allocation (e.g., mode 2) and network scheduling (e.g., mode 1). For wideband operation in sidelink unlicensed spectrum, the WTRU may be (e.g., pre-) configured with multiple LBT sub-bands. Mechanisms for performing LBT sub-band selection and resource allocation are described herein.

In NR U, the gNB is the receiver for the UL resource scheduled by the network. The gNB may be aware of the UL transmission status. In sidelink, the network may not be aware of the SL transmission in its scheduled sidelink resource. Mechanism for coordinating between the gNB and the WTRU regarding sidelink scheduling to deal with the unpredictability of the LBT procedure are described herein.

If the WTRU acquires two contiguous LBT sub-bands, it may be beneficial for the system and the WTRU to use the guard-band between the two LBT sub-bands. The Rx WTRU may not be aware of such a decision. Mechanisms to coordinate and optimize the guard-band usage are described herein.

Two metrics may be used to characterize a channel state, allowing a WTRU to take actions: a channel busy ratio (CBR) and a channel occupancy ratio (CR). The channel busy ratio (CBR) may be seen as the portion of subchannels in the resource pool whose measured received signal strength may exceed a (e.g., pre-) configured threshold. Such metric may be sensed, for example over the last hundred subframes/slots. The CBR may provide an estimation on the total state of the channel. The channel occupancy ratio (CR) which may be determined at subframe/slot (e.g., n), may be seen as the total number of subchannels used for its transmissions in previous subframes/slots (e.g., [n−a, n−1] and granted in upcoming subframes/slots (e.g., [n, n+b]) divided by the total number of subchannels (e.g., within [n−a, n+b]), where a, b and n may be integer numbers determined by the WTRU. The CR may provide an indication on the channel utilization by the transmitter itself.

### Methods and Apparatus for Wideband Operation in SL U

In embodiments described herein, the term “LBT sub-band” may be used interchangeably with the “set of LBT sub-bands”, “resource pool”, “sidelink carrier”, “bandwidth part (BWP)”, “sub-band” and “resource block (RB) set”.

In embodiments described herein, the term “reserved resource” may be used to describe the resource reserved for LBT and/or transmission. The term “resource” may be used interchangeably with the term “COT”.

In embodiments described herein, a resource may be used to describe a set of smaller resources, wherein each smaller resource can be used for one transmission.

In embodiments described herein, “puncturing/rematching a transmission” may be used interchangeably with the action of “determining the duration of one transmission”.

In embodiments described herein, received signal strength indicator (RSSI), reference signal received power (RSRP), and reference signal received quality (RSRQ) may be used interchangeably to refer to a quality metric representative of a signal quality.

In embodiments described herein, “physical sidelink control channel (PSCCH)/physical sidelink shared channel (PSSCH) transmission” may be used interchangeably with “SL transmission”.

In embodiments described herein a “number” and a “percentage” of (e.g., acquired) resources over a set of (e.g., scheduled) resources collectively “number/percentage” may be used interchangeably to refer to a subset of (e.g., acquired) resources within a set of (e.g., scheduled) resources, such as e.g., a ratio of (e.g., acquired) resources over (e.g., scheduled) resources.

### Methods for WTRU Autonomous Resource Allocation

### The LBT Parameters

In some embodiments, the WTRU may perform LBT before transmission. The WTRU may determine one or any combination of the following LBT parameters:
LBT type for multi-channel access (e.g., LBT type A, A1, A2, B, B1, B2);
LBT type for one LBT sub-band channel access (e.g., LBT type 1, 2, 2A, 2B, 2C);
LBT category in one LBT sub-band (e.g., LBT CAT 1, 2, 4);
The channel access priority class (CAPC);
Contention window size, which may include the current contention window (CWₚ), the lower bound (e.g., minimum), and/or the upper bound (e.g., maximum) contention window associated with the channel access priority class p (e.g., CWₚ, CW_{min,p}, and CW_{max,p});
Any of the current value and the initial value of the backoff counter (N);
The COT duration, which may include the current COT and/or the maximum COT;
The defer period (T_{d});
The LBT energy detection threshold used to determine the availability of a channel;
The fixed frame period (FFP) configuration; and
The clear channel access (CCA) duration.

Herein, LBT parameters may include one or any combination of the parameters related to the channel access procedure. The parameters may include, but are not limited to, the LBT type for multi-channel access, LBT type for one LBT sub-band channel access, LBT category in one LBT sub-band, CAPC, contention window size (which may include CWₚ, CW_{min,p}, and CW_{max,p}), the current or initialized backoff counter N, the COT duration, the defer period, the LBT energy detection, the FFP configuration, and the CCA duration.

### WTRU Determining the LBT Parameters to Access the Channel

In some embodiments, the WTRU may determine one or any combination of the LBT parameters based on one or any combination of the following two examples.

In a first example, the WTRU may determine any of the LBT parameters based on any of a QoS of the TB, a sidelink radio bearer (SLRB), and a logical channel (LCH). Herein, the QoS of the TB, SLRB and/or LCH may include one or more of the priority, latency, reliability, range requirement, data rate, remaining packet delay budget (PDB), type of data traffic (e.g., whether the data is periodic or aperiodic), periodicity of the traffic, type of HARQ feedback (e.g., whether the TB, SLRB and/or LCH is HARQ enabled, disabled, or a mixture of HARQ enabled and disabled), cast type of the TB (e.g., whether the TB, SLRB, and/or LCH is associated with unicast, groupcast, and/or broadcast), the size of the TB, remaining PDB (e.g., for retransmission of a TB), and one or more LBT parameters used to access the channel to transmit the TB.

In a second example, the WTRU may determine any of the LBT parameters based on any of TB size, a buffer status of the WTRU and a channel busy ratio (CBR) of the resource pool and/or LBT sub-band.

WTRU Determining the Resource Size to Perform LBT and/or Resource Allocation

In one embodiment, the WTRU may determine the resource size to perform LBT and/or transmission. The resource size may include the bandwidth or minimum bandwidth and/or the duration or minimum duration of each resource to perform LBT and/or transmission. In one approach, the WTRU may perform LBT and/or transmission for resources having at least M consecutive subchannels spanning over at least N slots, where M and N are integers. In another approach, the WTRU may perform LBT and/or transmission for the resources having at least M consecutive LBT sub-bands spanning over at least N slots. This approach may be motivated to optimize the number of attempts to access the channel.

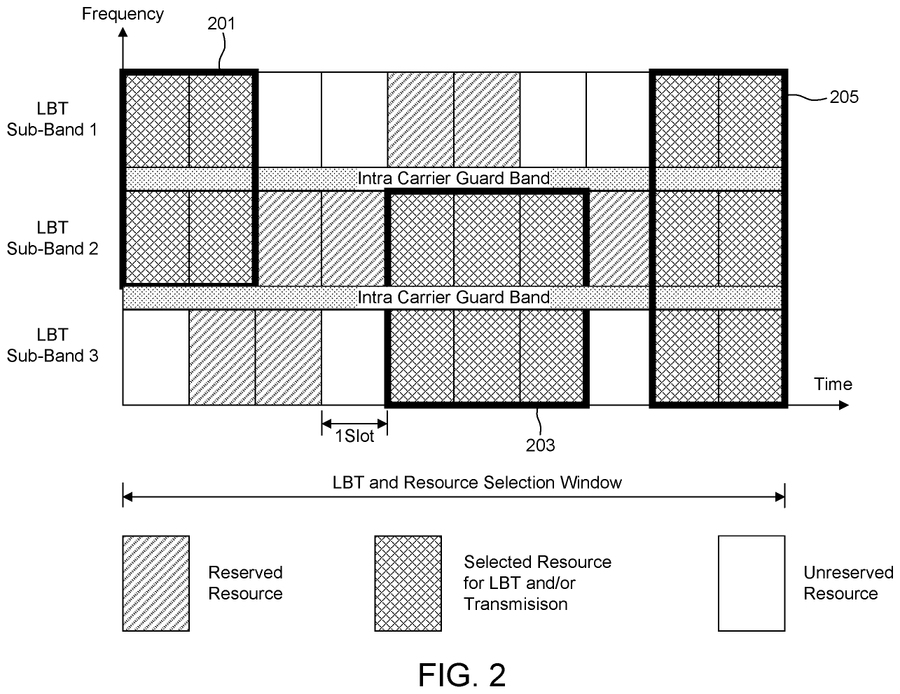

In one example shown in FIG. 2, the WTRU may be (e.g., pre-) configured to perform transmission in a resource pool having three LBT sub-bands. The WTRU may determine to perform LBT and/or transmission in the resource having the size of at least two contiguous LBT sub-bands spanning over at least two slots. The WTRU may then select the resources in the rectangles as shown at 201, 203, 205, which may comprise resources, to perform LBT and/or transmission. The resources in the rectangles shown at 201, 203, 205 satisfy the resource size requirement of at least (e.g., a minimum of) two LBT sub-bands spanning over at least (e.g., a minimum of) two slots.

The WTRU may determine the resource size (e.g., which may comprise any of a minimum, M, LBT sub-bands spanning over at least N slots) to perform LBT and/or transmission based on one or any combination of the following six examples.

In a first example the WTRU may determine the resource size based on a (e.g., pre-) configuration in the resource pool. For example, the WTRU may be (e.g., pre-) configured with the values of M and/or N to perform LBT and/or transmission. The WTRU may then select the values of M and/or N based on the (pre-) configuration.

In a second example the WTRU may determine the resource size based on the size of the TB. For example, the WTRU may be (e.g., pre-) configured with a range of resource sizes (e.g., the minimum M LBT sub-bands spanning over a minimum of N slots) to perform LBT and/or transmission based on the TB size. The WTRU may (e.g., then) determine the value of M and/or N to perform LBT and/or transmission based on the TB size.

In a third example the WTRU may determine the resource size based on the CBR of the resource pool and/or LBT sub-band. For example, the WTRU may be (e.g., pre-) configured with a range of resource sizes to perform LBT and/or transmission based on the CBR of the resource pool and/or LBT sub-band. The WTRU may (e.g., then) determine which resource size to select to perform LBT and/or transmission based on the measured CBR of the resource pool and/or LBT sub-band. For example, the WTRU may use a smaller resource size if CBR of the resource pool and/or LBT sub-band is larger than a threshold. The WTRU may use a larger resource size if the CBR of the resource pool and/or LBT sub-band is smaller than the threshold.

In a fourth example the WTRU may determine the resource size based on any of the QoS of the TB, SLRB, and LCH. For example, the WTRU may be (e.g., pre-) configured with a range of resource sizes to perform LBT and/or transmission based on the QoS of the TB (e.g., the priority of the TB). The WTRU may then determine which resource size to use to perform LBT and/or transmission based on the QoS associated with the TB.

In a fifth example the WTRU may determine the resource size based on one or more LBT parameters used to access the channel. In one example, the WTRU may determine the resource size to perform LBT and/or transmission based on the LBT type for multi-channel access. For example, the WTRU may be (e.g., pre-) configured with a range of resource sizes of minimum, M, LBT sub-bands spanning over N slots for each LBT type for multi-channel access. For example, the WTRU may be (e.g., pre-) configured with the resource size of one LBT sub-band spanning over one slot for LBT type A. Alternatively, the WTRU may be (e.g., pre-) configured with the resource size of two LBT sub-bands spanning over two slots for LBT type B. In another example, the WTRU may determine the resource size to use to perform LBT and/or transmission based on the CAPC of the TB. For example, the WTRU may be (e.g., pre-) configured with one range of resource size to perform LBT and/or transmission based on the CAPC of the TB. The WTRU may then determine which resource size to use to perform LBT and/or transmission based on the CAPC of the TB and the (e.g., pre-) configured the resource sizes range. For example, the WTRU may select a small resource size for high CAPC priority (i.e., low CAPC value) and may select a large resource size for low CAPC priority (e.g., high CAPC value). This approach may allow the low CAPC data to access more resources based on longer LBT time. In yet another example, the WTRU may determine the resource size to use to perform LBT and/or transmission based on the current contention window (CWₚ) and/or the backoff value, N. The WTRU may be (e.g., pre-) configured with a range of resource sizes for each contention window and/or backoff value. The WTRU may then determine which resource size to use for LBT and/or transmission based on the contention window (CWₚ) and/or the backoff value N.

In a sixth example the WTRU may determine the resource size based on a buffer status of the WTRU (e.g., the amount of data in the buffer and/or the amount of data in a (e.g., pre-) configured set of logical channels (LCHs)). In one example, for each range of the total amount of data in the buffer, the WTRU may be (e.g., pre-) configured with a maximum/minimum of M LBT sub-bands and/or a maximum/minimum of N slots to use for LBT. The WTRU may then determine which value of M and/or N to use based on the amount of the data in the buffer. For example, if the WTRU has total data in the buffer less than the first (e.g., pre-) configured threshold, the WTRU may use the resource size of one RB-set and one slot. For example, if the total amount of data is greater than the first threshold and smaller than a second threshold, the WTRU may use the resource size of two RB-sets and one slot or one RB-set and two slots. For example, if the total amount of data is greater than a third threshold, the WTRU may use the resource size of two RB-sets and two slots or three RB-sets and one slot. In yet another example, the WTRU may determine the resource size (e.g., maximum value of M and/or N) based on the amount of data having priority greater than a (e.g., pre-) configured threshold.

WTRU Performing LBT and/or Transmission Scheme in Wideband Operation of One TB

In some embodiments, the WTRU may perform one or any combination of the following LBT and/or transmission schemes in wideband operation for one TB.

In a first scheme, the WTRU may first select one LBT sub-band. The WTRU may perform LBT and/or transmission of the TB in the selected LBT sub-band. The WTRU may perform (e.g., all) transmissions of the TB (e.g., initial transmission and retransmission(s)) in the same LBT sub-band.

In a second scheme, the WTRU may perform LBT and/or transmission of the TB in multiple LBT sub-bands. For example, the WTRU may select one LBT sub-band to perform LBT and/or transmission for a (e.g., each) transmission of the TB. The WTRU may select the resources for LBT and/or transmission such that the two resources in two LBT sub-bands may not overlap.

In a third scheme, the WTRU may perform one LBT type (e.g., any of type A, B, A1, A2, B1, B2) to access multiple LBT sub-bands. The WTRU may perform transmission in a (e.g., each) sub-band when LBT succeeds. If the WTRU acquires multiple LBT sub-bands in one slot, the WTRU may perform multiple transmissions of the TB (e.g., one initial transmission and one or more retransmissions) in the same slot, in which each transmission may be associated with one LBT sub-band. The WTRU may indicate (e.g., in the sidelink control information (SCI)) that the WTRU may perform multiple transmissions of the TB in the same slot. The WTRU may indicate the information about the transmissions in the same slot, which may implicitly or explicitly include the set of LBT sub-bands. This approach may allow to help the Rx WTRU in TB decoding.

In a fourth scheme, the WTRU may perform one LBT type (e.g., any of type A, B, A1, A2, B1, B2) to access multiple LBT sub-bands. If the WTRU acquires multiple LBT sub-bands in one slot, the WTRU may perform one transmission of the TB spanning over the acquired LBT sub-bands. The WTRU may acquire the contiguous LBT sub-bands to perform such transmission. If the WTRU acquires non-contiguous LBT sub-bands, the WTRU may perform transmission in a subset of the acquired LBT sub-bands, which may be the contiguous sub-bands. The WTRU may indicate (e.g., in SCI) the set of sub-bands used for transmission of the TB. The WTRU may transmit one SCI in one of the LBT sub-bands (e.g., the lowest/highest index LBT sub-band).

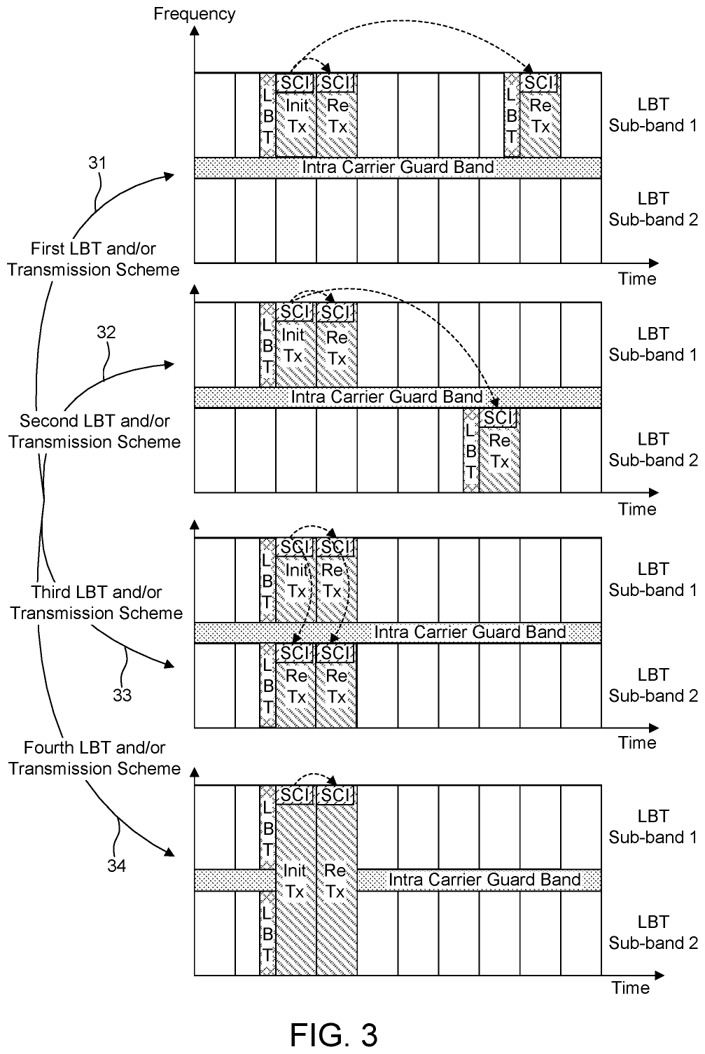

In one example shown in FIG. 3, the WTRU may perform one of the four LBT and/or transmission schemes discussed above for one TB. For example, the WTRU may be configured with two LBT sub-bands (e.g., LBT sub-band 1 and 2) to perform wideband operation. In the first LBT and/or transmission scheme shown at 31 in FIG. 3, the WTRU may first select one LBT sub-band (e.g., LBT sub-band 1) to perform LBT and/or transmission. The WTRU may then select the resources to perform LBT and potential transmissions.

In the second LBT and/or transmission scheme shown at 32 in FIG. 3, the WTRU may select each resource for LBT and/or transmission. The WTRU may then perform two first transmissions in the first LBT sub-band. The WTRU may then perform the last transmission of the TB in the second LBT sub-band.

In the third LBT and/or transmission scheme shown at 33 in FIG. 3, the WTRU may perform LBT and acquire two LBT sub-bands e.g., simultaneously. The WTRU may then perform transmissions of one TB in two LBT sub-bands spanning over two slots. In each slot, the WTRU may perform two transmissions, each transmission may be within one LBT sub-band.

Different from the third scheme, in the fourth scheme shown at 34, in each slot, the WTRU may perform one transmission of a TB spanning over two LBT sub-bands. The guard band may be used in the third and fourth schemes shown at 33 and 34.

WTRU Performing LBT and/or Transmission Scheme in Wideband Operation of Multiple TBs

The WTRU may perform one or any combination of the following LBT and/or transmission schemes in wideband operation for multiple TBs:

In a first scheme (e.g., which may be referred to as scheme A), the WTRU may perform one LBT type (e.g., type A, B, A1, A2, B1, B2) to access multiple LBT sub-bands. The WTRU may perform transmission of each TB in the set of acquired LBT sub-bands. The WTRU may perform one or more transmissions of a TB, in which a (e.g., each) transmission of a TB may be within a LBT sub-band. The WTRU may perform one transmission (e.g., initial transmission) of a TB in one LBT sub-band and one or more other transmissions (e.g., retransmission) of the TB in other LBT sub-bands. Each transmission of the TB may occupy one slot. The WTRU may perform transmissions of the TB in one or more slots.

In a second scheme (e.g., which may be referred to as scheme B), the WTRU may perform one LBT type (e.g., type A, B, A1, A2, B1, B2) to access multiple LBT sub-bands. The WTRU may perform transmission of a (e.g., each) TB in the set of acquired LBT sub-bands. The WTRU may perform one or more transmissions of the TB in multiple LBT sub-bands, in which each transmission may span over multiple LBT sub-bands (e.g., over multiple (e.g., all the) acquired LBT sub-bands).

In a third scheme (e.g., which may be referred to as scheme C), the WTRU may combine the first and second schemes, in which the WTRU may use the first scheme for one set of TBs (e.g., the first one or more TBs transmitted in the COT) and may use the second scheme for another set of TBs (e.g., the last one or more TBs transmitted in the COT).

In a fourth scheme (e.g., which may be referred to as scheme D), the WTRU may select a LBT sub-band to perform LBT and/or transmission for each TB. The WTRU may use the same or different LBT sub-bands for multiple TBs. The WTRU may perform one LBT type (e.g., type, A, B, A1, A2, B1, B2) to access multiple LBT sub-bands. If LBT succeeds in one LBT sub-band, the WTRU may perform transmission of the associated TB in the LBT sub-band.

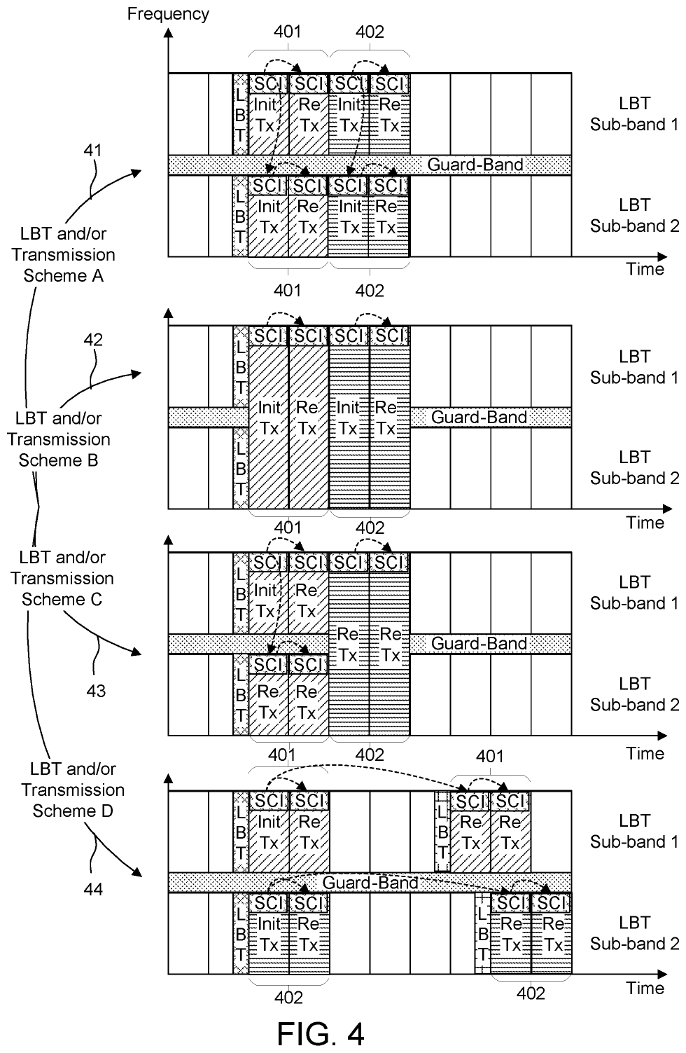

In one example shown in FIG. 4, the WTRU may perform one of four LBT and/or transmission schemes for multiple TBs. For example, in the first LBT and/or transmission scheme shown at 41 in FIG. 4, the WTRU may perform LBT and may acquire two LBT sub-bands in the same time slot. The WTRU may perform multiple transmissions of a TB in one time slot, in which each transmission may be within one LBT sub-band. As shown in FIG. 4, the WTRU may perform transmission of two TBs in which the transmissions of the first TB are in slant hatched rectangles as shown at 401 and the transmissions of the second TB are in the horizontally hatched rectangles as show at 402. The WTRU may perform four transmissions of each TB spanning over two time slots. In each time slot, the WTRU may perform two transmissions of one TB, in which each transmission may be within one LBT sub-band.

In the second LBT and/or transmission scheme shown at 42 in FIG. 4, the WTRU may perform one transmission of one TB in each slot, which may span over multiple acquired LBT sub-bands.

In the third LBT and/or transmission scheme shown at 43 in FIG. 4, the WTRU may use the first scheme for the first TB and the second scheme for the second TB.

In the fourth scheme shown at 44 in FIG. 4, the WTRU may select the first and second LBT sub-band for the first and second TBs, respectively. The WTRU may then perform LBT and/or transmission of each TB in each LBT sub-band independently.

WTRU Indicating its LBT and/or Transmission Scheme to Another Network Element

The WTRU may indicate (e.g., transmit information indicating) its LBT and/or transmission scheme to other network elements (e.g., one or more receiver WTRUs). The WTRU may use one or any combination of NAS, PC5 radio resource control (RRC), MAC control element (MAC CE), and/or SCI to indicate its LBT and/or transmission scheme. In one example, the WTRU may use one or more SCIs (e.g., second stage SCI) associated with one or more transmissions of a TB to indicate whether the TB is spanning over multiple sub-bands or within one LBT sub-band. The WTRU may use SCI to indicate whether it performs multiple transmissions of a TB in a slot. The WTRU may (e.g., also) use SCI to indicate the set of LBT sub-bands to perform simultaneous transmissions of the TB in the same slot.

WTRU Determining which LBT and/or Transmission Scheme to Use for Wideband Operation

In some embodiments, the WTRU may determine which LBT and/or transmission scheme to use for wideband operation based on one or any combination of the following ten examples.

In a first example, the WTRU may determine which LBT and/or transmission scheme to use for wideband operation based on being (e.g., pre-) configured in the resource pool. For example, the WTRU may be configured with resource pool information indicating whether to perform transmissions of a TB in one or more LBT sub-bands. For example, the WTRU may be (e.g., pre-) configured with one or more LBT types (e.g., any of type A, B, A1, A2, B1, B2) for multiple channel access. The WTRU may then use one of the (e.g., pre-) configured LBT types to access multiple channels.

In a second example, the WTRU may determine which LBT and/or transmission scheme to use for wideband operation based on whether guard-band is (e.g., pre-) configured in the resource pool. In an example, for transmission of one TB, the WTRU may determine the LBT scheme based on whether guard-band is (e.g., pre-) configured in the resource pool. For example, if guard-band is not (e.g., pre-) configured in the resource pool, the WTRU may determine to perform one type of LBT procedure for multi-channel access (e.g., any of LBT type A2, B, B1, B2, in which the LBT procedure in one LBT sub-band depends on the LBT procedure in another LBT sub-band). Otherwise, if guard-band is (e.g., pre-) configured in the resource pool, the WTRU may perform any type of LBT for multi-channel access (e.g., LBT type A1). In another example, the WTRU may determine the transmission scheme based on whether guard-band is (e.g., pre-) configured in the resource pool. For example, if guard-band is not (e.g., pre-) configured in the resource pool, the WTRU may perform one transmission of a TB spanning over multiple LBT sub-bands. Otherwise, if guard-band is (e.g., pre-) configured in the resource pool, the WTRU may perform multiple transmissions of the TB in the same slot, in which each transmission may be within one LBT sub-band.

In a third example, the WTRU may determine which LBT and/or transmission scheme to use for wideband operation based on the set of acquired LBT sub-bands. For example, if the WTRU acquires a set of contiguous LBT sub-bands, the WTRU may select one LBT and/or transmission scheme (e.g., the fourth LBT and/or transmission scheme for one TB shown in FIG. 3, in which each transmission may be within one LBT sub-band). For example, if the WTRU acquires non-contiguous LBT sub-bands, the WTRU may use another LBT and/or transmission scheme (e.g., the third LBT and/or transmission scheme for one TB shown in FIG. 3, in which each transmission may span multiple LBT sub-bands).

In a fourth example, the WTRU may determine which LBT and/or transmission scheme to use for wideband operation based on a QoS associated with any of the TB, a SLRB, and an LCH. For example, the WTRU may select one LBT and/or transmission scheme (e.g., the first LBT and/or transmission scheme as shown in FIG. 3 for one TB) if the reliability of the TB is larger than a threshold. Otherwise, if the reliability of the TB is smaller than the threshold, the WTRU may select another LBT and/or transmission scheme (e.g., the second LBT and/or transmission scheme for one TB shown in FIG. 3).

In a fifth example, the WTRU may determine which LBT and/or transmission scheme to use for wideband operation based on the size of the TB. For example, the WTRU may select one LBT and/or transmission scheme for one TB (e.g., the first or second LBT and/or transmission scheme for one TB shown in FIG. 3) if the size of the TB is smaller than a threshold; otherwise, the WTRU may select another LBT and/or transmission scheme (e.g., the third or the fourth LBT and/or transmission scheme for one TB shown in FIG. 3, in which the WTRU may perform simultaneous transmission of the TB in multiple LBT sub-bands) if the size of the TB is larger than the threshold. The TB size threshold may be (e.g., pre-) configured in the resource pool.

In a sixth example, the WTRU may determine which LBT and/or transmission scheme to use for wideband operation based on a buffer status of the WTRU. For example, if the buffer size of the WTRU is smaller than a threshold, the WTRU may select one LBT and/or transmission scheme (e.g., LBT and/or transmission scheme D for multiple TBs as shown in FIG. 4, in which the WTRU may select one LBT sub-band for each TB). Otherwise, if the buffer size of the WTRU is larger than the threshold, the WTRU may select another LBT and/or transmission scheme (e.g., the LBT and/or transmission scheme C for multiple TBs as shown in FIG. 4, in which the WTRU may transmit one TB spanning over multiple LBT sub-bands). The buffer size threshold may be (e.g., pre-) configured in the resource pool.

In a seventh example, the WTRU may determine which LBT and/or transmission scheme to use for wideband operation based on the data rate (e.g., requirement) associated with the service. For example, if the data rate (e.g., requirement) associated with the sidelink service is smaller than a threshold, the WTRU may select one LBT and/or transmission scheme (e.g., LBT and/or transmission scheme D for multiple TBs as shown in FIG. 4, in which the WTRU may select one LBT sub-band for each TB). Otherwise, if the data rate of the WTRU is larger than the threshold, the WTRU may select another LBT and/or transmission scheme (e.g., the LBT and/or transmission scheme C as shown in FIG. 4, in which the WTRU may transmit one TB spanning over multiple LBT sub-bands). The buffer size threshold may be (e.g., pre-) configured in the resource pool.

In an eighth example, the WTRU may determine which LBT and/or transmission scheme to use for wideband operation based on the CBR of the resource pool and/or LBT sub-band. For example, the WTRU may select one LBT and/or transmission scheme (e.g., the first LBT and/or transmission scheme for one TB as shown in FIG. 3) if the CBR is greater than a threshold. Otherwise, the WTRU may select another LBT and/or transmission scheme (e.g., the second LBT and/or transmission scheme for one TB as shown in FIG. 3), if the CBR is smaller than the threshold.

In a ninth example, the WTRU may determine which LBT and/or transmission scheme to use for wideband operation based on the order of the transmission of the TB in the COT and/or the transmission slots of a COT. For example, the WTRU may select one LBT and/or transmission scheme for one TB (e.g., the first LBT and/or transmission scheme for one TB as shown in FIG. 3, in which the WTRU may perform multiple transmissions of a TB in a slot and each transmission may be within the LBT sub-band) for one or more TBs at the beginning of the COT. For example, the WTRU may select another LBT and/or transmission scheme for another TB (e.g., the second LBT and/or transmission scheme as shown in FIG. 3, in which the WTRU may perform one transmission of the TB in a slot spanning over multiple LBT sub-bands) for one or more TBs at the end of the COT or for the TB after the first one or more TBs of the COT.

In a tenth example, the WTRU may determine which LBT and/or transmission scheme to use for wideband operation based on the number of prepared TBs for LBT and/or transmission. For example, the WTRU may perform one LBT and/or transmission scheme (e.g., the first LBT and/or transmission scheme as shown in FIG. 3) if it has prepared one TB before LBT. Otherwise, the WTRU may perform another LBT and/or transmission scheme (e.g., the fourth LBT and/or transmission scheme as shown in FIG. 3) if it has prepared more than one TB (e.g., two TBs) before LBT.

WTRU Determining the Number of TBs to Prepare for LBT and/or Transmission in Wideband Operation

In one approach, the WTRU may prepare only one TB for one or more LBT and/or transmission occasions in a set of LBT sub-bands. In another approach, the WTRU may prepare multiple TBs for one or more LBT and/or transmission occasions. The WTRU may determine the number of TBs to prepare for one or more LBT and/or transmission occasions based on any of (i) the resource size to perform LBT and/or transmission and (ii) the set of LBT sub-bands to perform LBT and/or transmission.

For example, the WTRU may determine to prepare the number of TBs to be smaller than the number of LBT sub-bands for LBT and/or transmission in the resource size.

For example, the WTRU may be (e.g., pre-) configured with the maximum/minimum number of TBs to prepare based on the number of LBT sub-bands the WTRU may intend to use to perform LBT and/or transmission. The WTRU may then determine the number of TBs to prepare to satisfy the maximum/minimum (e.g., pre-) configured value.

For example, the WTRU may perform transmission for each TB in one LBT sub-band. The WTRU may then determine the number of TBs to prepare for wideband operation based on the number of LBT sub-bands the WTRU may intend to use to perform LBT and/or transmission. The WTRU may then determine the number of TBs to perform transmissions based on the number of acquired LBT sub-bands. For example, the WTRU may perform transmission of each TB in one acquired LBT sub-band.

WTRU Determining which TB to Transmit in a Set of Acquired LBT Sub-Bands

In some embodiments, the WTRU may prepare multiple TBs for wideband operation. The WTRU may perform LBT in a set of LBT sub-bands. The WTRU may acquire one or more LBT sub-bands. The WTRU may determine which TB to transmit in one or more acquired resources of one or more LBT sub-bands based on one or any combination of the following four examples.

In a first example, the WTRU may determine which TB to transmit in one or more acquired resources of one or more LBT sub-bands based on the LBT sub-band associated with the initial transmission of the TB. For example, the WTRU may determine which TB may be transmitted in the LBT sub-band based on whether the LBT sub-band is used for the initial transmission of the TB. For example, for one acquired COT in a LBT sub-band, the WTRU may prioritize the TB having initial transmission in the LBT sub-band.

In a second example, the WTRU may determine which TB to transmit in one or more acquired resources of one or more LBT sub-bands based on the QoS associated with the TB. For example, if the number of acquired LBT sub-bands is smaller than the number of acquired LBT sub-bands, the WTRU may select which TB to transmit based on the QoS of the TB. Specifically, the WTRU may prioritize the TB having higher priority to be transmitted first. In another example, the WTRU may determine which TB to transmit based on whether it performs initial transmission or retransmission of a TB. Specifically, the WTRU may prioritize retransmission of the TB over initial transmission of the TB in the acquired LBT sub-band.

In a third example, the WTRU may determine which TB to transmit in one or more acquired resources of one or more LBT sub-bands based on the remaining PDB of the TB. For example, the WTRU may determine whether to perform initial transmission of a TB or retransmission of another TB. In one approach, the WTRU may prioritize the TB for retransmission. In another approach, the WTRU may determine which TB to transmit in the resource based on the remaining PDB of the TB. For example, the WTRU may prioritize the TB having smaller remaining PDB. If the remaining PDB of the TB for retransmission is smaller than the PDB of the TB for initial transmission, the WTRU may prioritize the TB with retransmission. Otherwise, the WTRU may prioritize the TB with initial transmission.

In a fourth example, the WTRU may determine which TB to transmit in one or more acquired resources of one or more LBT sub-bands based on one or more LBT parameters associated with the TB. In one example, the WTRU may determine whether one TB can be transmitted in the acquired COT of the LBT sub-band based on one or more LBT parameters used to access the LBT sub-band. Specifically, the WTRU may be (e.g., pre-) configured with one or more LBT parameters to access the channel based on the QoS of the TB. Based on the value of one or more LBT parameters used to access the channel, the WTRU may determine which TB can access the channel (e.g., the TB having priority greater than a threshold). The WTRU may then perform transmission of the TB in the acquired COT if the QoS (e.g., priority) of the TB is greater than the threshold. Otherwise, the WTRU may not transmit the TB in the acquired COT. In another example, the WTRU may determine which TB to transmit in the acquired LBT sub-band based on the CAPC associated with the TB. Specifically, the WTRU may prioritize the TB having the lowest CAPC value (e.g., the highest priority).

### WTRU Determining to Perform LBT Sub-Band (Re-) Selection

In some embodiments, the WTRU may perform transmission in one set of LBT sub-bands. The WTRU may trigger LBT sub-band (re-) selection. For example, the WTRU may determine which LBT sub-bands to select or to reselect for its transmission. For LBT sub-band selection, the WTRU may select the set of LBT sub-bands to perform LBT and/or transmission. For LBT sub-band reselection, the WTRU may reselect a different or the same set of LBT sub-bands. The WTRU may (re-) select one primary LBT sub-band to perform one type of LBT (e.g., type 1 LBT) for one type of multi-channel LBT (e.g., type B LBT). The LBT sub-band (re-) selection may be triggered based on one or any combination of the following nine examples of events (e.g., based on any of the following conditions being satisfied).

In a first example, the LBT sub-band (re-) selection may be triggered based on the number of available resources (e.g., slots) within a window (e.g., the resource selection window) being smaller than a threshold. For example, the WTRU may be (e.g., pre-) configured with a threshold of the number/percentage of available resources (e.g., available slots) to trigger LBT sub-band (re-) selection. The WTRU may first determine the set of available resources (e.g., slots) in the window (e.g., resource selection window). If the percentage/number of the available resources is smaller than the (e.g., pre-) configured value, the WTRU may trigger sub-band (re-) selection. Otherwise, the WTRU may use the current LBT sub-band.

In a second example, the LBT sub-band (re-) selection may be triggered based on the reserved resource(s) in the current set of LBT sub-band(s) being pre-empted. For example, the WTRU may trigger LBT sub-band (re-) selection if one or more of its reserved resource(s) is pre-empted.

In a third example, the LBT sub-band (re-) selection may be triggered based on the WTRU triggering resource (re) selection. For example, the WTRU may trigger LBT sub-band (re-) selection if it triggers resource (re) selection.

In a fourth example, the LBT sub-band (re-) selection may be triggered based on the WTRU failing to access the channel after a number of LBT attempts. For example, the WTRU may select a (e.g., certain) number of resources (e.g., slots) to perform LBT before transmission. The WTRU may trigger LBT sub-band switching if the number of LBT failures is larger than a threshold. The threshold may be (e.g., pre-) configured in the resource pool, which may be a function of any of the QoS of the TB, one or more LBT parameters, and the CBR of the resource pool.

In a fifth example, the LBT sub-band (re-) selection may be triggered based on the WTRU failing to access the channel after a period. For example, the WTRU may perform LBT to access the channel for transmission of one or more TBs. The WTRU may trigger LBT sub-band (re-) selection if the WTRU fails to access the channel after a (e.g., pre-) configured period. The (e.g., pre-) configured period may be a function of any of the QoS of the TB, one or more LBT parameters (e.g., CAPC, contention window, etc.)., and the CBR of the resource pool and/or LBT sub-band.

In a sixth example, the LBT sub-band (re-) selection may be triggered based on the number of transmissions for one or more TBs within a period being smaller than a threshold. For example, the WTRU may trigger LBT sub-band (re-) selection if the number of transmissions performed for one or more TBs within a period threshold is smaller than a threshold. The number of transmissions threshold and/or the period threshold may be (e.g., pre-) configured in the resource pool, which may be a function of any of the QoS of the TB, one or more LBT parameters, and the CBR of the resource pool.

In a seventh example, the LBT sub-band (re-) selection may be triggered based on the WTRU failing to transmit one or more TBs. For example, the WTRU may trigger LBT sub-band reselection if it fails to transmit a (e.g., certain) number of TBs. The number of failed TB transmissions to trigger LBT sub-band (re-) selection may be (e.g., pre-) configured in the resource pool, which may depend on any of the QoS of the TB, CBR of the resource pool, and one or more LBT parameters used to access the channel. The WTRU may consider whether one TB transmission has failed based on any of (i) the number of transmissions for the TB (e.g., within the PDB of the TB) being smaller than a threshold (which may be a function of the QoS of the TB) and (ii) the WTRU not receiving any ACK feedback within the PDB of the TB from the Rx WTRU to acknowledge the reception of the TB or the WTRU receiving a NACK feedback from the Rx WTRU to indicate the reception failure.

In an eighth example, the LBT sub-band (re-) selection may be triggered based on one or more LBT parameters meeting a (e.g., pre-configured) condition for LBT sub-band (re-) selection. For example, the WTRU may be (e.g., pre-) configured to perform LBT sub-band (re-) selection if it uses the maximum contention window value (i.e., CWₚ=CWₘₐₓ) for any of a (e.g., pre-) configured period, a (e.g., pre-) configured number of times, and a (e.g., pre-) configured number of COTs.

In a ninth example, the LBT sub-band (re-) selection may be triggered based on the CBR of one or more LBT sub-bands in the current set of LBT sub-band(s) being greater than a threshold. For example, the WTRU may trigger LBT sub-band (re) selection if the CBR of its current LBT sub-band is larger than a threshold. The threshold may be (e.g., pre-) configured in the resource pool.

WTRU Determining the Set of LBT Sub-Bands to Perform LBT and/or Transmission

In some embodiments, the WTRU may perform LBT sub-band (re-) selection by performing one or any combination of the following two examples of operations.

In a first example of operation, the WTRU may select one LBT sub-band or one set of LBT sub-band(s) to perform LBT and/or transmission of one or more TBs.

In a second example of operation, for multi-channel access, the WTRU may determine the LBT sub-band (i.e., primary LBT sub-band) to perform one type of LBT (e.g., type 1 LBT). If LBT succeeds in the selected LBT sub-band, the WTRU may determine to select a set of LBT sub-bands to perform another type of LBT type (e.g., the WTRU may sense each LBT sub-band for a sensing interval of at least T_{mc}=25 μs). The WTRU may then determine the set of LBT sub-bands to perform transmission from the set of successful LBT sub-bands.

The WTRU may determine the set of LBT sub-band(s) to perform LBT and/or transmission based on one or any combination of the following ten examples.

In a first example, the WTRU may determine the set of LBT sub-band(s) to perform LBT and/or transmission based on the CBR of the LBT sub-band. In one example, the WTRU may select the LBT sub-band having a CBR smaller than a threshold. Specifically, the WTRU may be (e.g., pre-) configured with a CBR threshold for selecting for a LBT sub-band. The WTRU may be allowed to select the LBT sub-band if the CBR of the LBT sub-band is smaller than the threshold. Otherwise, the WTRU may not select the LBT sub-band. If the WTRU has multiple LBT sub-bands having CBR below the threshold, in one approach, the WTRU may select the LBT sub-band having the lowest CBR. In another approach, the WTRU may (e.g., randomly) select one LBT sub-band from the set of LBT sub-bands satisfying the CBR threshold.

In a second example, the WTRU may determine the set of LBT sub-band(s) to perform LBT and/or transmission based on the set of available resources in a window (e.g., resource selection window). For example, the WTRU may be (e.g., pre-) configured with a threshold of the number/percentage of available resources (e.g., available slots) to perform LBT and/or transmission in a LBT sub-band. The WTRU may select the LBT sub-band if the number/percentage of the available resources (e.g., slots) to perform LBT and/or transmission is larger than the threshold. Otherwise, the WTRU may not select the LBT sub-band. If the WTRU has multiple LBT sub-bands having the number/percentage of available resources smaller than the threshold, in one approach, the WTRU may select the LBT sub-band having the highest number/percentage of available resources. In another example, the WTRU may (e.g., randomly) select one LBT sub-band from the set of LBT sub-bands satisfying the threshold.

In a third example, the WTRU may determine the set of LBT sub-band(s) to perform LBT and/or transmission based on the selected primary LBT sub-band for wideband operation. For example, upon LBT success in the primary LBT sub-band, the WTRU may select the LBT sub-band to perform transmission after sensing that the channel may be idle for at least T_{mc}=25 μs. The WTRU may select the secondary LBT sub-band for transmission to satisfy contiguity with the primary LBT sub-band. Specifically, the WTRU may prioritize transmission in the primary LBT sub-band and the two contiguous LBT sub-bands thereto. For example, the WTRU may acquire the set of LBT sub-bands to perform transmission. If the set of acquired LBT sub-bands are non-contiguous, the WTRU may drop one or more of the LBT sub-band(s), resulting in non-contiguous transmission with the primary LBT sub-band.

In a fourth example, the WTRU may determine the set of LBT sub-band(s) to perform LBT and/or transmission based on the destination associated with the TB. For example, the WTRU may be (e.g., pre-) configured with a set of LBT sub-bands for a (e.g., each) destination (e.g., for each destination ID, each unicast pair, each groupcast ID, etc.). The WTRU may then determine the set of LBT sub-bands to perform LBT and/or transmission on based on the (e.g., pre-) configured LBT sub-bands for the destination. The (pre-) configuration may be based on the association between the LBT sub-band and the service. The (pre-) configuration may be based on a negotiation between the WTRUs in the group (e.g., for unicast, groupcast), in which the WTRU may use PC5 RRC to convey such negotiation.

In a fifth example, the WTRU may determine the set of LBT sub-band(s) to perform LBT and/or transmission based on whether HARQ feedback resource is (e.g., pre-) configured in the LBT sub-band. For example, for HARQ enabled TB, the WTRU may prioritize the LBT sub-band having (e.g., pre-) configured HARQ feedback resources. For HARQ disabled TB, the WTRU may prioritize the LBT sub-band without (e.g., pre-) configured HARQ feedback resources.

In a sixth example, the WTRU may determine the set of LBT sub-band(s) to perform LBT and/or transmission based on one or more LBT parameters used to access each LBT sub-band. For example, the WTRU may select the LBT sub-band having a contention window (e.g., value) smaller than a threshold. Specifically, the WTRU may be (e.g., pre-) configured with a contention window threshold (e.g., a threshold for CWₚ, CW_{min,p}, or CW_{max,p}) for selecting a LBT sub-band. The WTRU may be allowed to select the LBT sub-band if the contention window (e.g., value) of the LBT sub-band is smaller than the threshold. Otherwise, the WTRU may not select the LBT sub-band. If the WTRU has multiple LBT sub-bands having contention windows (e.g., values) below the threshold, in one approach, the WTRU may select the LBT sub-band having the lowest value of the contention window. In another approach, the WTRU may (e.g., randomly) select one LBT sub-band from the set of LBT sub-bands satisfying the contention window threshold.

In a seventh example, the WTRU may determine the set of LBT sub-band(s) to perform LBT and/or transmission based on the earliest available resource of a (e.g., each) LBT sub-band. For example, the WTRU may prioritize the LBT sub-band having the earliest resource (e.g., slot) for LBT and/or transmission.

In an eighth example, the WTRU may determine the set of LBT sub-band(s) to perform LBT and/or transmission based on the first successful sub-band in LBT. For example, the WTRU may perform LBT in the set of LBT sub-bands, the WTRU may then perform transmission in the first acquired LBT sub-band.

In a ninth example, the WTRU may determine the set of LBT sub-band(s) to perform LBT and/or transmission based on the availability of a sharable COT in one LBT sub-band. For example, the WTRU may prioritize selecting an LBT sub-band having a sharable COT within the resource selection window. The WTRU may share COT with another WTRU using frequency division multiplexing (e.g., the WTRU may use orthogonal interlaces with the interlace used by the COT initiator WTRU or using time division multiplexing (e.g., the WTRU may perform transmission after the other WTRU finishing its transmission).

In a tenth example, the WTRU may determine the set of LBT sub-band(s) to perform LBT and/or transmission based on an implicit/explicit indication from another network element. Specifically, the WTRU may implicitly/explicitly receive an indication from the Rx WTRU to perform LBT and/or transmission in one LBT sub-band. The WTRU may then select the LBT sub-band to perform LBT and/or transmission. In one example, the WTRU may receive HARQ ACK/NACK feedback from one Rx WTRU. The Tx WTRU may then select the LBT sub-band having HARQ feedback from the Rx WTRU to perform LBT and/or transmission. In another example, the WTRU may receive an indication from the Rx WTRU (e.g., via a PC5 radio resource control (RRC) message) to perform LBT and/or transmission in one LBT sub-band. The WTRU may then perform LBT and/or transmission in the indicated LBT sub-band. In another example, the WTRU may receive a transmission from a peer WTRU in one LBT sub-band. The WTRU may then select that LBT sub-band to perform LBT and/or transmission. In another example, the WTRU may receive a sensing information (e.g., set of available resources) in one LBT sub-band. The WTRU may then select the LBT sub-band having the sensing information to perform LBT and/or transmission.

WTRU Determining Whether to Keep the Current Set of LBT Sub-Band(s) to Perform LBT and/or Transmission

In some embodiments, the WTRU may semi-statically use one set of LBT sub-bands to perform LBT and/or transmission. The WTRU may trigger resource allocation (e.g., for any of a new TB and a retransmission of an existing TB). The WTRU may determine whether to keep the current set of LBT sub-band(s) to perform LBT and/or transmission based on one or any combination of the following five examples.

In a first example, the WTRU may determine whether to keep the current set of LBT sub-band(s) to perform LBT and/or transmission based on the CBR of the resource pool and/or LBT sub-band. For example, the WTRU may determine to keep the current LBT sub-band if the CBR of the LBT sub-band is smaller than a threshold. Otherwise, the WTRU may switch to another LBT sub-band to perform LBT and/or transmission.

In a second example, the WTRU may determine whether to keep the current set of LBT sub-band(s) to perform LBT and/or transmission based on the availability of a sharable COT in the current set of LBT sub-bands. For example, the WTRU may keep the current set of LBT sub-bands if the WTRU detects a sharable COT in the current set of LBT sub-band(s).

In a third example, the WTRU may determine whether to keep the current set of LBT sub-band(s) to perform LBT and/or transmission based on the availability of a sharable COT in another set of LBT sub-bands. For example, the WTRU may switch to another LBT sub-band if the WTRU detects a sharable COT in another set of LBT sub-bands within the resource selection window.

In a fourth example, the WTRU may determine whether to keep the current set of LBT sub-band(s) to perform LBT and/or transmission based on one or more LBT parameters meeting a (e.g., pre-) configured condition for keeping the LBT sub-band. In one example, the WTRU may be (e.g., pre-) configured with a contention window threshold (e.g., the threshold of CWₚ, CW_{min,p}, and CW_{max,p}) to keep the current set of LBT sub-band(s). The WTRU may keep the current set of LBT sub-bands if the contention window (e.g., value) satisfies the (e.g., pre-) configured threshold (e.g., CWₚ is smaller than the CWₚ threshold). Otherwise, the WTRU may switch to another set of LBT sub-band(s). In another example, the WTRU may be (e.g., pre-) configured with an initialized backoff value threshold to keep the current set of LBT sub-band(s). The WTRU may keep the current set of LBT sub-bands if the initialized backoff value is smaller than a threshold. Otherwise, the WTRU may switch to another set of LBT sub-band(s).

In a fifth example, the WTRU may determine whether to keep the current set of LBT sub-band(s) to perform LBT and/or transmission based on the number of available resources (e.g., slots) to perform LBT and/or transmission in a window (e.g., resource selection window). For example, the WTRU may be (e.g., pre-) configured with a threshold of the number/percentage of available resources (e.g., available slots) to perform LBT and/or transmission to keep the current set of LBT sub-band(s). The WTRU may keep the current set of LBT sub-band(s) if the number/percentage of the available resources (e.g., slots) is larger than the threshold. Otherwise, the WTRU may select a different set of LBT sub-band(s).

WTRU Determining the Available Resources (e.g., Slots) for LBT and/or Transmission

In some embodiments, the WTRU may determine the set of available resources (e.g., slots) in the resource selection window to perform LBT and/or transmission. Specifically, the WTRU may determine one resource (e.g., slot) as available if the resource satisfies one or any combination of the following two examples of conditions.

In a first example, the WTRU may determine one resource (e.g., slot) as available if the resource is not reserved by any WTRU.

In a second example, the WTRU may determine one resource (e.g., slot) as available if the resource is reserved by another WTRU, and a sidelink reference signal receive power (SL-RSRP) is smaller than a threshold. In one approach, the threshold may be fixed, which may be a function of a channel idle detection threshold. In another approach, the threshold may be based on any of: (i) one or more LBT parameters of the reserving WTRU used to reserve the channel, (ii) a QoS of the reserving TB, (iii) one or more LBT parameters of the WTRU used to access the channel, and (iv) a QoS of the TB and/or SLRB/LCH.

WTRU Determining which Slot to Perform LBT and/or Transmission of One or More TB

In some embodiments, the WTRU may (e.g., first) determine the set of available resources (e.g., slots) from SCI decoding in a resource selection window. A resource selection window may be a window (e.g., of slots which may be referred as [n+T1, n+T2]) starting after a first offset (e.g., T1) from the slot (e.g., n) where the WTRU may have triggered a resource selection and ending after a second offset (e.g., T2) from the slot where the WTRU may have triggered the resource selection. The WTRU may (e.g., then) perform one or any combination of the following to select the resource (e.g., slot) to perform LBT and/or transmission.

In a first approach, the WTRU may select the set of the first (e.g., initial) N resources (e.g., slots) in the resource selection window for possible LBT and/or transmission (N may be referred to as an integer number). The first (e.g., initial) N resources (e.g., slots) may be located at the beginning of the resource selection window. In one approach, the WTRU may select the N resources from one LBT sub-band. In another approach, the WTRU may select the N resources from multiple LBT sub-bands. The WTRU may (e.g., randomly) select one resource (e.g., slot) to perform LBT and/or transmission from the set of first N resources. If the WTRU successfully acquires the channel, the WTRU may perform transmission in the selected resource. Otherwise, if the WTRU fails to access the channel, in one approach, the WTRU may (e.g., randomly) select another resource (e.g., slot) from the remaining resources in the N resources. In another approach, the WTRU may perform LBT on the next available resource (e.g., slot). The value of N (e.g., any of minimum value, maximum value, and exact value) may be (e.g., pre-) configured in the resource pool and/or may be a function of any of the QoS of the TB (e.g., any of priority and remaining PDB), one or more LBT parameters (e.g., contention window), and CBR of the resource pool.

In a second approach, the WTRU may select a window (e.g., resource selection sub-window), which may be located at the beginning of the resource selection window. The WTRU may then (e.g., randomly) select one resource (e.g., slot) from the set of available resources to perform LBT and/or transmission within the resource selection sub-window. If the WTRU successfully acquires the channel, the WTRU may perform transmission in the selected resource. Otherwise, if the WTRU fails to access the channel, in one approach, the WTRU may (e.g., randomly) select another resource (e.g., slot) from the resource allocation sub-window. In another approach, the WTRU may perform LBT on the next available resource (e.g., slot). The size of the resource selection sub-window (e.g., any of minimum size, maximum size, exact size) may be (e.g., pre-) configured in the resource pool and/or may be a function of any of the QoS of the TB (e.g., priority or remaining PDB), one or more LBT parameters, and CBR of the resource pool.

In the above first and second approaches, the WTRU may (e.g., randomly) select the resource (e.g., slot) to perform LBT and/or transmission to reduce collision among different WTRUs performing LBT at the same time.

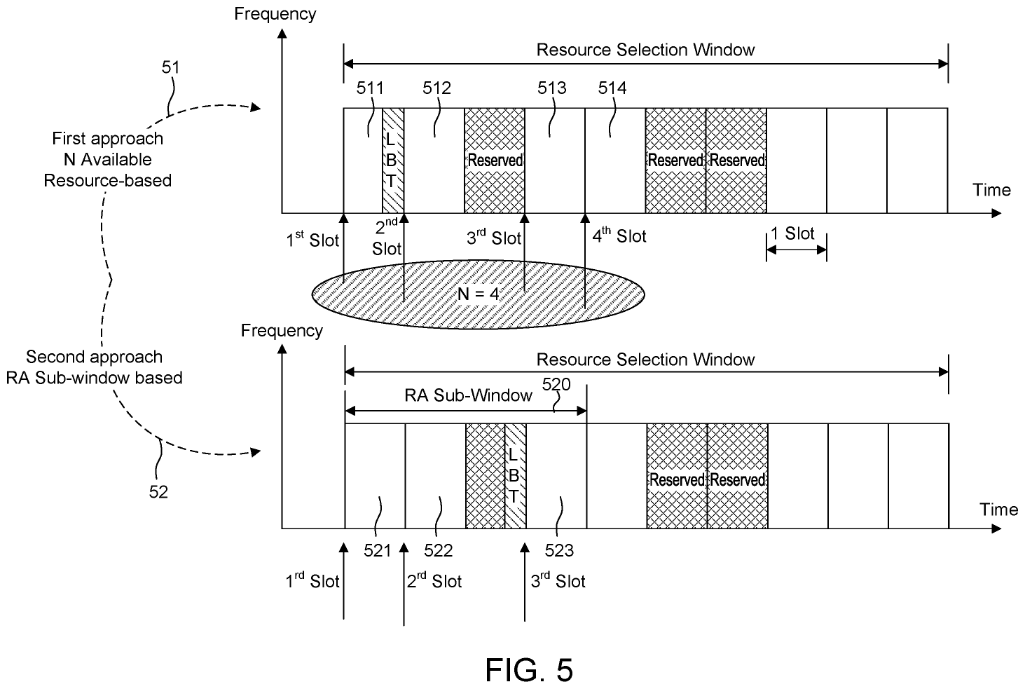

In one example shown in FIG. 5, the WTRU may perform one of the two options (e.g., first approach 51 vs. second approach 52) to determine the first slot for LBT and/or transmission. In the first approach 51, the WTRU may select the first N=4 available slots 511, 512, 513, 514. The WTRU may then (e.g., randomly) select one slot (e.g., the 2nd slot 512 in FIG. 5) out of the N=4 available slots to perform LBT and/or transmission. In the second approach, the WTRU may determine the resource allocation (RA) sub-window 520 to determine the first slot in which to perform LBT and/or transmission. In the sub-window 520, the WTRU may have three available slots 521, 522, 523. The WTRU may then (e.g., randomly) select one of those three slots (e.g., the 3rd slot 523 in FIG. 5) to perform LBT and/or transmission.

### WTRU Determining to Perform Contiguous LBT

In some embodiments, the WTRU may perform contiguous LBT until it acquires the LBT sub-band to perform transmission. The WTRU may first select the first resource (e.g., slot) to perform LBT, which may be determined based on one or any combination of the following three approaches.

In a first approach, the WTRU may perform SCI decoding to determine the set of available resources. The WTRU may then (e.g., randomly) select one resource from the set of first N available resources (e.g., slots) or it may (e.g., randomly) select one available resource (e.g., slot) from the set of N available resources. The WTRU may then perform contiguous LBT until it acquires the LBT sub-band. The value of N (e.g., any of minimum (e.g., lower) value, maximum (e.g., upper) value, exact value) may be (e.g., pre-) configured in the resource pool, which may be a function of any of the QoS of the TB (e.g., priority and/or remaining PDB), one or more LBT parameters (e.g., contention window), and CBR of the resource pool.

In a second approach, the WTRU may perform SCI decoding to determine the set of available resources. The WTRU may then (e.g., randomly) select one resource (e.g., slot) in a sub-window from the set of available resources in the sub-window. The WTRU may then perform contiguous LBT until it acquires the LBT sub-band. The size of the sub-window (e.g., any of minimum (e.g., lower) size, maximum (e.g., upper) size, exact size) may be (e.g., pre-) configured in the resource pool, which may be a function of any of the QoS of the TB (e.g., priority and/or remaining PDB), one or more LBT parameters, and CBR of the resource pool.

In a third approach, the WTRU may not perform SCI decoding to determine the available resources in the resource selection window. The WTRU may first (e.g., randomly) select one resource (e.g., slot) in a sub-window (e.g., RA sub-window) to perform LBT and/or transmission. The WTRU may then perform contiguous LBT until it acquires the LBT sub-band. The size of the sub-window (e.g., any of minimum (e.g., lower) size, maximum (e.g., upper) size, exact size) may be (e.g., pre-) configured in the resource pool, which may be a function of any of the QoS of the TB (e.g., priority and/or remaining PDB), one or more LBT parameters, and CBR of the resource pool.

In the above approaches, the WTRU may select the resource (e.g., slot) to perform LBT and/or transmission to reduce collision among different WTRUs performing LBT at the same time.

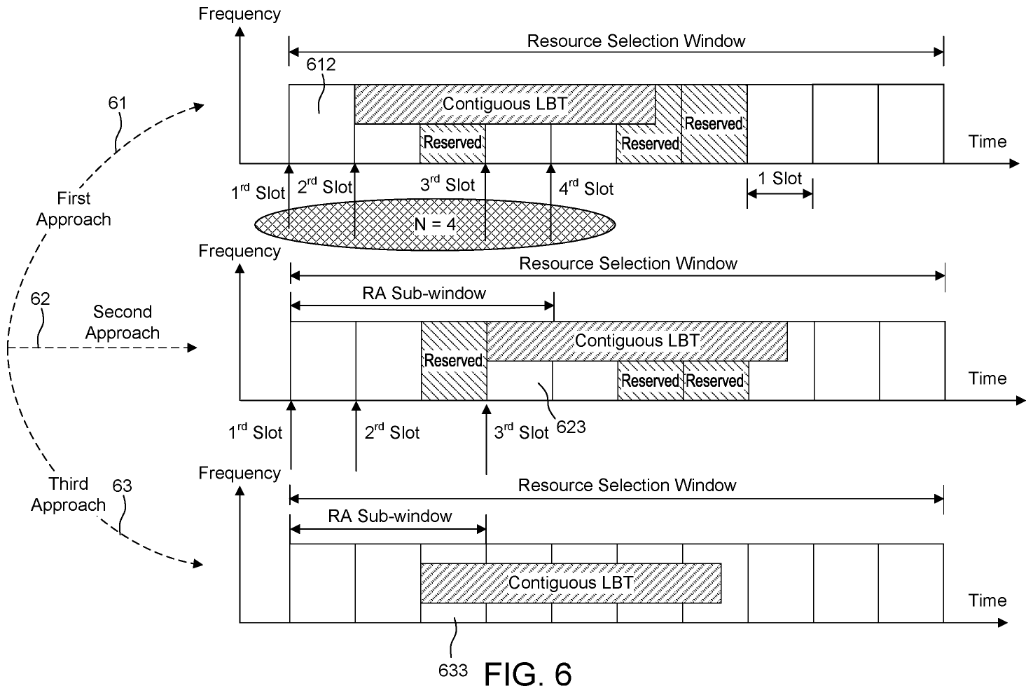

In one example shown in FIG. 6, the WTRU may perform one of the three approaches 61, 62, 63 to determine the first slot to perform LBT and/or transmission. After the first slot may be selected, the WTRU may perform contiguous sensing until it acquires the LBT sub-band. The WTRU may perform SCI decoding to determine the set of available resources in the first 61 and second 62 approaches. In the first approach 61, illustrated in the top portion of FIG. 6, the WTRU may (e.g., randomly) select one slot (e.g., the 2nd slot shown at 612 in FIG. 6) from the set of first N available slots. In the second approach 62, illustrated in the middle portion of FIG. 6, the WTRU may (e.g., randomly) select one slot (e.g., the third slot shown at 623 in FIG. 6) from a set of available slots in a sub-window. In the third approach 63, illustrated in the bottom portion of FIG. 6, the WTRU may not perform SCI decoding to determine the set of available resources. The WTRU may (e.g., randomly) select one slot (e.g., the third slot shown at 633 in FIG. 6) in a sub-window to perform LBT.

WTRU Determining the Availability of One Reserved Resource and/or COT from Another WTRU

In some embodiments, the WTRU may receive SCI from another WTRU reserving a resource and/or a COT. The WTRU may determine whether the reserved resource and/or COT is available or not. For example, if the reserved resource (e.g., reserved COT) is available, the WTRU may include it in the set of resources for selection and transmission. Otherwise, if the reserved resource is not available, the WTRU may exclude it from the set of resources for selection and transmission. The WTRU may determine whether the reserved resource is available based on any of the QoS, CAPC, one or more LBT parameters, and SL-RSRP associated with the reserved resource and/or any of the QoS, CAPC, and one or more LBT parameters associated with the data of the WTRU. In one example, if the CAPC associated with the data of the WTRU is greater than the CAPC associated with the reserved resource, the WTRU may consider (e.g., determine) the reserved resource to be available. Otherwise, the WTRU may consider (e.g., determine) the reserved resource to be unavailable. In another example, if the CAPC associated with the reserved resource is greater than a (e.g., pre-) configured threshold, the WTRU may consider (e.g., determine) the reserved resource to be unavailable. Otherwise, the WTRU may consider (e.g., determine) the reserved resource to be unavailable.

WTRU Determining the Availability of One or More Slots after the COT of Another WTRU

In some embodiments, the WTRU may determine the availability of a resource for transmission and/or reservation. The WTRU may determine the availability of one or more slots after the COT of another WTRU. For example, the WTRU may determine whether one or more slots after the COT of another WTRU is/are available or not based on one or any combination of the following two examples.

In a first example, the WTRU may determine whether one or more slots after the COT of another WTRU is/are available or not based on the QoS of the TB, and/or one or more LBT parameters of the WTRU. For example, the WTRU may determine the first slot after the reserved COT of another WTRU as available if the QoS of the TB and/or the CAPC of the TB is smaller than a threshold. For example, the WTRU may consider (e.g., determine) one slot after the reserved COT of another WTRU as unavailable if the QoS of the TB and/or the CAPC of the TB is greater than a threshold and smaller than another threshold. For example, the WTRU may consider (e.g., determine) N≥2 slots after the reserved COT of another WTRU as unavailable if the QoS of the TB and/or the CAPC of the TB is smaller than a threshold. This approach may allow the WTRU to reserve time for LBT after COT of another WTRU.

In a second example, the WTRU may determine whether one or more slots after the COT of another WTRU is/are available or not based on the QoS associated with the reserved COT, and/or one or more LBT parameters associated with the reserved COT.

### WTRU Puncturing/Rate Matching the Transmission Before a Reserved Resource/COT of Another WTRU

In some embodiments, the WTRU may rate match/puncture a portion of the transmission resource in the last transmission before the reserved resource/COT of another WTRU. Herein rate matching/puncturing a transmission may be used interchangeably with the WTRU procedure to determine the duration of a transmission, which may expect the WTRU to not perform transmission of one or more symbols. The WTRU may then implicitly and/or explicitly indicate the puncturing/rate matching duration or transmission duration (e.g., in the SCI), which may be used to support the reception WTRU to decode the TB. The rate match/puncture duration may be determined based on one or any combination of the following four examples.

In a first example, rate match/puncture duration may be determined based on a (e.g., pre-) configuration in the resource pool. In an example, the WTRU may be (e.g., pre-) configured to puncture/rate match a portion of the resources in the last transmission before a reserved resource/COT. The WTRU may then follow the (e.g., pre-) configured value to determine the duration to puncture/rate match. In another example, the WTRU may be (e.g., pre-) configured to stop transmission of one or more symbols before a reserved resource (e.g., COT) of another WTRU. The WTRU may then determine to stop transmission at that point.

In a second example, rate match/puncture duration may be determined based on being implicitly and/or explicitly indicated in the transmission reserving the resource (e.g., SCI). In one example, the WTRU may determine the rate matching/puncturing duration based on the indicated LBT duration (e.g., the expected LBT duration) to access the channel of the other WTRU (e.g., the WTRU reserving the resource/COT). The LBT duration may be indicated in the SCI. In another example, the WTRU may determine the rate matching/puncturing duration based on one or more LBT parameters (e.g., contention window value) and/or one or more QoS parameters (e.g., priority) indicated in the transmission (e.g., SCI) of the reserving WTRU.

In a third example, rate match/puncture duration may be determined based on the QoS of the TB and/or one or more LBT parameters used to access the LBT sub-band.

In a fourth example, rate match/puncture duration may be determined based on the CBR of the resource pool and/or LBT sub-band.

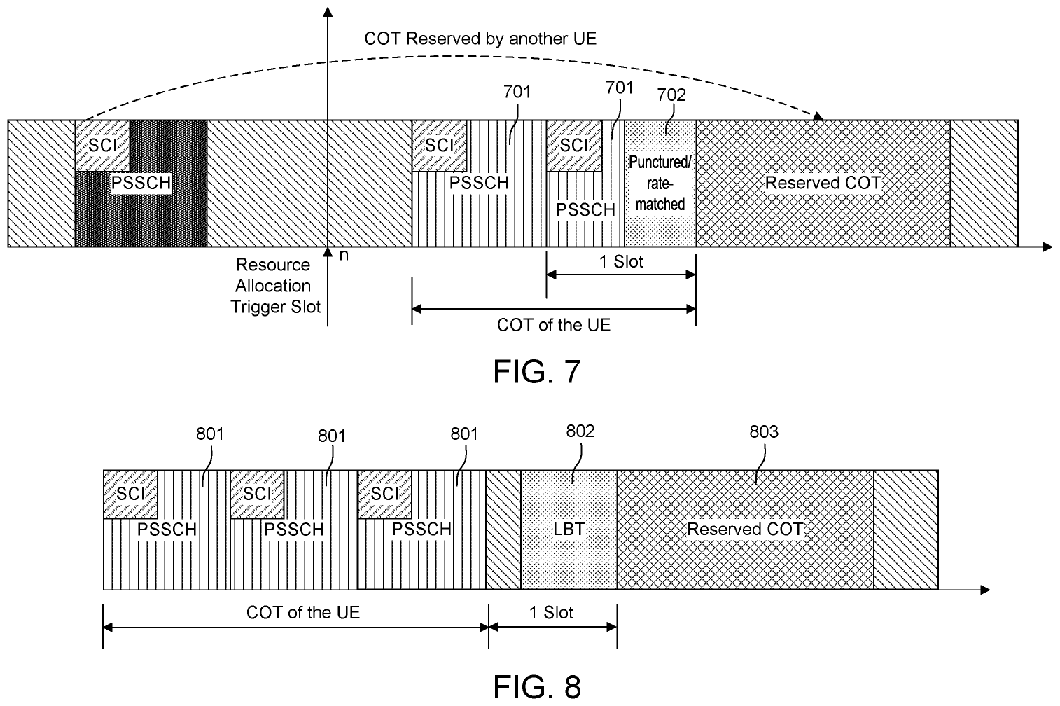

In one example shown in FIG. 7, the WTRU may obtain the COT and perform transmissions in the vertically hatched rectangles shown at 701. The WTRU may (e.g., intend to) perform two transmissions in the COT. In the last transmission, the WTRU may rate match/puncture several symbols to help (e.g., assist) other WTRU perform LBT (e.g., in the rectangle shown at 702).

### WTRU Puncturing/Rate Matching in the Last Transmission of its COT

The WTRU may determine the transmission duration in the last transmission of the COT. For example, the WTRU may puncture/rate match in the last transmission of its COT, which may be used to facilitate the LBT procedure of other WTRUs. The WTRU may determine any of (i) whether to rate match/puncture in the last transmission of its COT, (ii) the puncturing/rate matching duration and (iii) the transmission duration of the last transmission of the COT.

The transmission and/or the puncturing/rate matching duration of the last transmission may be determined based on one or any combination of the following four examples.

In a first example, the transmission and/or the puncturing/rate matching duration of the last transmission may be determined based on whether the COT is sharable. For example, the WTRU may be (e.g., pre-) configured with a gap duration between the last transmission in the COT and the slot boundary for use with sharable COTs. The WTRU may determine the duration of the last transmission to be punctured/rate matched to satisfy the (e.g., pre-) configured gap between the last transmission and the slot boundary. For example, if the COT is not sharable, the WTRU may perform transmission in a full slot. In this scenario, the WTRU may also use the last symbol as a guard symbol for Tx/Rx switching.

In a second example, the transmission and/or the puncturing/rate matching duration of the last transmission may be determined based on whether there is any reserved resource after the last transmission: For example, if there is any reserved resource after the last transmission, the WTRU may determine to puncture/rate match for a duration (e.g., one or more symbols) in its last transmission of the COT.

In a third example, the transmission and/or the puncturing/rate matching duration of the last transmission may be determined based on the QoS of the TB and/or one or more LBT parameters used to access the LBT sub-band.

In a fourth example, the transmission and/or the puncturing/rate matching duration of the last transmission may be determined based on the CBR of the resource pool and/or LBT sub-band.

### WTRU Determining to Puncture/Rate Match in a Simultaneous Multiple LBT Sub-Bands Transmission

In some embodiments, the WTRU may perform simultaneous transmission over multiple LBT sub-bands. The WTRU may determine the transmission duration in the last transmission of the COT based on the transmission duration in each LBT sub-band. For example, the transmission duration over multiple LBT sub-bands may be the minimum (e.g., lowest) transmission duration of all LBT sub-bands. The WTRU may indicate to another node (e.g., in the SCI) the transmission duration of multiple LBT sub-bands for wideband operation. This approach may allow the WTRU to finish its transmission at the same time for all LBT sub-bands.

### WTRU Terminating its COT for a Duration Before a Reserved Resource

The WTRU may terminate its COT (e.g., early COT termination) for a duration (e.g., one or more slots) before a reserved resource (e.g., reserved COT) of another WTRU. The early COT termination duration may be determined based on any of a (pre-) configuration of the resource pool and one or more LBT/QoS parameters of the reserving COT, and/or the WTRU. One or more LBT/QoS parameters of the reserving COT may be indicated in the transmission reserving the COT (e.g., SCI). For example, the transmission stop duration may be determined based on the CAPC and/or the contention window indicated in the reserved resource. This approach may allow the WTRU reserving the COT to have enough time to clear the channel before the reserved resource.

In one example shown in FIG. 8, the WTRU may acquire the COT and perform transmission in its COT, which is shown in the vertically hatched rectangles at 801. The WTRU may determine not to perform transmission one slot before the reserved COT of another WTRU. The other WTRU may then perform LBT, which is shown at 802, to clear the channel. The COT reserving WTRU may perform transmission in the reserved COT 803.

### WTRU Terminating its COT for a Duration for Wideband Operation

The WTRU may terminate its COT (e.g., early COT termination) for a duration (e.g., one or more slots) for wideband operation (e.g., over multiple LBT sub-bands). For example, the WTRU may detect a reserved COT of another WTRU in one or more LBT sub-bands, and the WTRU may then determine to perform early COT termination (e.g., stop transmission of one or more slots before the reserved COT) in that one or more LBT sub-bands. The WTRU may perform early termination of the COT over the whole wideband. The early termination duration of the COT may be determined based on the early termination of each LBT sub-band. For example, the termination duration of the COT for wideband operation may be the longest termination among (e.g., of each LBT sub-band in) the set of LBT sub-bands used for wideband operation.

### WTRU Reserving Resources for (e.g., Potential) Transmission

The WTRU may reserve one or more resources (e.g., COT) for (e.g., potential) transmission(s). In one approach, the WTRU may reserve resource(s) to perform LBT and/or transmission. In another approach, the WTRU may reserve the resource(s) for transmissions only. The WTRU may indicate (e.g., transmit information indicating) whether the reserved resource is for LBT and/or transmission. The WTRU may determine whether to reserve a resource (e.g., a future COT) for a future (e.g., upcoming) transmission based on one or any combination of the following four examples.

In a first example, the WTRU may determine whether to reserve a resource for one or more upcoming transmissions based on any of the QoS of the TB, SLRB, and LCH. For example, the WTRU may be (e.g., pre-) configured with a condition of a (e.g., certain) QoS parameters to reserve a resource (e.g., a future COT). If the QoS of the TB is not satisfied, the WTRU may not reserve the resource. Otherwise, the WTRU may reserve the resource.

In a second example, the WTRU may determine whether to reserve a resource for one or more upcoming transmissions based on the CBR of the resource pool and/or LBT sub-band. For example, the WTRU may be (e.g., pre-) configured with a range of CBR to reserve a resource (e.g., a future COT). The WTRU may determine to reserve the resource if the CBR is within the range. Otherwise, the WTRU may not reserve the resource. The CBR range may be (e.g., pre-) configured as a function of any of the QoS of the TB, SLRB, and LCH. The CBR range may be (e.g., pre-) configured as a function of any of the CAPC of the TB, SLRB, and LCH.

In a third example, the WTRU may determine whether to reserve a resource for one or more upcoming transmissions based on CAPC of the SLRB, and/or LCH. For example, the WTRU may be (e.g., pre-) configured with a range of CAPC to reserve a resource (e.g., a future COT). The WTRU may determine to reserve the resource if the CAPC of the TB, SLRB, and/or LCH is within the range. Otherwise, the WTRU may not reserve the resource. The CBR range may be (e.g., pre-) configured as a function of any of the QoS of the TB, SLRB, and LCH.

In a fourth example, the WTRU may determine whether to reserve a resource for one or more upcoming transmissions based on one or more LBT parameters used to access the resource. For example, the WTRU may be (e.g., pre-) configured with a range of contention window (CWₚ) to reserve a resource (e.g., a future COT). The WTRU may determine to reserve the resource if the contention window is within the range. Otherwise, the WTRU may not reserve the resource.

### WTRU Deferring/Postponing its Transmission to a Future Slot

In some embodiments, the WTRU may defer/postpone its transmission to a future resource upon LBT success (e.g., backoff counter reaching 0, N=0). The WTRU may not perform sensing in the defer period (Ta) to perform transmission after N reaching 0. The WTRU may then resume its LBT (e.g., short LBT) in a future slot. The WTRU may defer its transmission if the time gap between the LBT success and the reserved COT of another WTRU is smaller than a threshold. The WTRU may then resume its LBT and transmission after the reserved COT. This approach may allow the WTRU to select more resources for transmission of the TB. The time gap threshold, which may be used to determine whether to defer its transmission or not, may be determined based on one or any combination of the following four examples.

In a first example, the time gap threshold may be determined based on a (e.g., pre-) configuration in the resource pool. For example, the WTRU may be (e.g., pre-) configured to defer/postpone its LBT and/or transmission if the LBT success time is one slot before the reserved COT of another WTRU. The WTRU may determine to defer/postpone its transmission if the time gap between LBT success and the reserved COT of another WTRU is smaller than one slot.

In a second example, the time gap threshold may be determined based on the QoS of the TB. For example, the WTRU may be (e.g., pre-) configured with a time gap to defer/postpone its transmission based on the QoS of the TB (e.g., the reliability or HARQ type of the TB). The WTRU may then determine the time gap threshold to defer/postpone its transmission based on the QoS of the TB. The WTRU may determine to defer/postpone its LBT and/or transmission if the time gap is within the determined time gap threshold.

In a third example, the time gap threshold may be determined based on the QoS associated with the reserved COT of another WTRU.

In a fourth example, the time gap threshold may be determined based on the CBR of the resource pool. For example, the WTRU may be (e.g., pre-) configured with a time gap threshold to defer its transmission as a function of the CBR of the resource pool. The WTRU may determine the time gap threshold to defer/postpone its transmission based on the CBR of the resource pool. The WTRU may determine whether to defer/postpone its transmission based on whether the time gap between LBT success and reserved COT of another WTRU is greater than the determined time gap threshold.

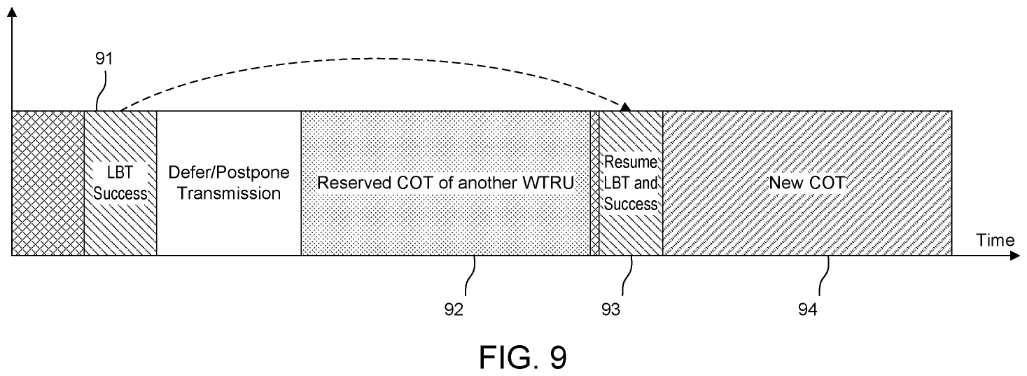

In one example shown in FIG. 9, the WTRU may be successful in a LBT procedure as shown at 91 before a reserved COT 92 of another WTRU. The WTRU may defer its transmission in the window between the LBT success time and the reserved COT of another WTRU. The WTRU may resume its LBT as shown at 93 and may acquire a new COT 94 after the reserved COT 92 of the other WTRU.

WTRU Determining which Slots are Unavailable to Perform LBT and Transmission

In one embodiment, the WTRU may determine the set of slots in which to perform LBT and transmission. For example, the WTRU may perform LBT before the slot boundary and may transmit PSCCH/PSSCH from the slot boundary. The WTRU may consider (e.g., determine) the following slots as unavailable for LBT and transmission.

The WTRU may determine as unavailable for LBT and transmission the slots reserved by another WTRU if frequency division multiplexing (FDM) between two WTRUs in the same slot is not allowed in the resource pool.

The WTRU may determine as unavailable for LBT and transmission X slots after a reserved slot, which the WTRU may consider unusable for transmission (e.g., due to a conflict with the reserving WTRU). X may be an integer value.

The WTRU may determine as unavailable for LBT and transmission Y slots before a reserved slot, which the WTRU may consider unusable for transmission (e.g., due to conflict with the reserving WTRU). Y may be an integer value.

The value of X and/or Y may be determined based on one or any combination of the following examples.

In a first example, the value of X and/or Y may be determined based on a (e.g., pre-) configuration in the resource pool. For example, the WTRU may be (e.g., pre-) configured with the value of X and Y (e.g., X=1, Y=1 for 15 KHz sub-carrier spacing (SCS); X=2, Y=2 for 30 KHz SCS).

In a second example, the value of X and/or Y may be determined based on the SCS (e.g., pre-) configured in the resource pool. For example, the value of X and Y may be higher for higher SCSs.

In a third example, the value of X and/or Y may be determined based on one or more LBT parameters used by the WTRU to access the channel (e.g., any of CAPC, CWₚ, CW_{min,p}, CW_{max,p}, the initial value of the backoff counter N, defer period, etc.). For example, the value of X may be determined based on one or more LBT parameters used by the WTRU to access the channel. In one example, the WTRU may be (e.g., pre-) configured with a value of X as a function of CAPC. The WTRU may determine the value of X based on the CAPC used to access the channel.

In a fourth example, the value of X and/or Y may be determined based on one or more LBT parameters used by the WTRU reserving a slot (e.g., any of CAPC, CWₚ, CW_{min,p}, CW_{max,p}, the initial value of the backoff counter N, defer period, etc.). For example, the value of Y may be determined based on one or more LBT parameters used by the reserving WTRU to access the channel. In one example, the WTRU may be (e.g., pre-) configured with a value of Y as a function of CAPC. The WTRU may determine the value of Y based on the CAPC used by the reserving WTRU to access the channel.

WTRU Determining which Slots May be Available Slots to Perform LBT and Transmission

The WTRU may determine the set of available slots to perform LBT and transmission based on the set of unavailable slots. For example, from the set of total slots in the resource selection window, the WTRU may exclude the set of unavailable slots. The remaining set of slots may be considered (e.g., determined) as the set of available slots. The WTRU may perform LBT and transmission using slots from the set of available slots.

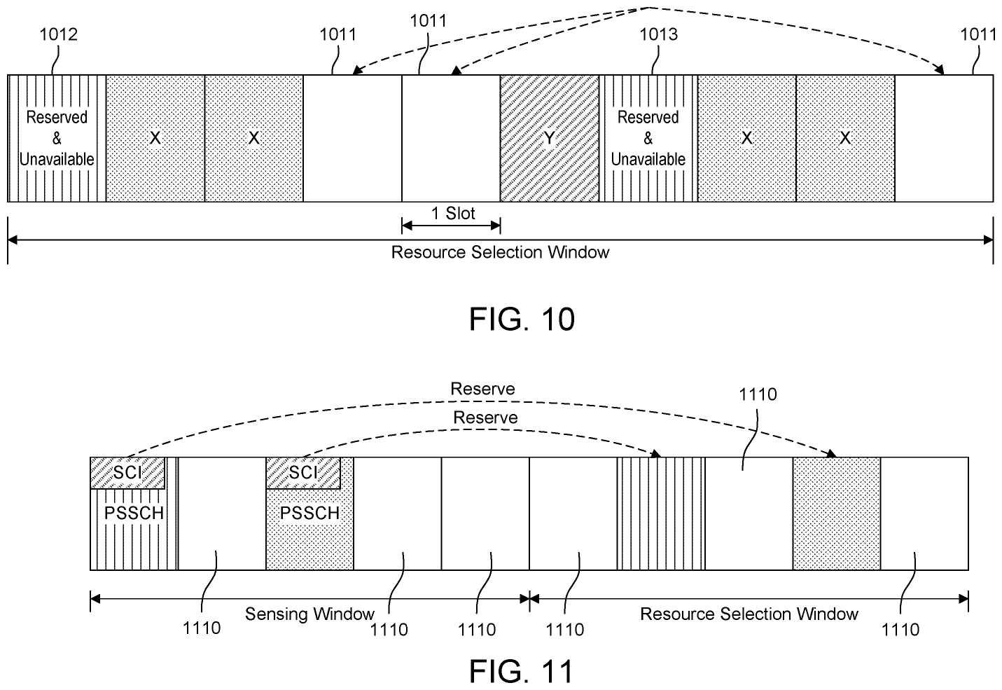

In one example shown in FIG. 10, the WTRU may perform resource allocation in a resource selection window. In FIG. 10, the white slots 1011 may be considered (e.g., determined) to be available. The WTRU may detect and determine that there may be two reserved slots 1012, 1013, which may be considered (e.g., determined) unavailable for LBT and transmission. The WTRU may determine that X=2 slots (e.g., after elimination of the first reserved and unavailable slot 1012), and Y=1 slot (e.g., before the second reserved and unavailable slot 1013). The WTRU may not be able to transmit in the determined slots. In case frequency division multiplexing (FDM) between two WTRUs is allowed and there are available frequency resources (e.g., available interlaces) in the two reserved slots, the WTRU may consider the two reserved slots as available. Otherwise, if FDM is not allowed, the WTRU may consider the two reserved slots as unavailable.

### WTRU Determining Whether One Reserving Resource is Available or Unavailable

In one embodiment, the WTRU may perform resource selection in a resource selection window, in which the WTRU may perform sensing by decoding SCI in the sensing window before the resource selection window. If one resource is reserved in the resource selection window, the WTRU may determine whether the reserved resource is available based on one or more of the following two examples.

In a first example, the WTRU may determine whether the reserved resource is available based on the RSSI measured in the transmission reserving the resource. For example, if the RSSI measured in the transmission reserving the resource is greater than a (e.g., pre-) configured threshold, the WTRU may consider (e.g., determine) the resource as unavailable. Otherwise, the WTRU may consider (e.g., determine) the resource as available. The threshold may be as a function of LBT energy detection threshold and a (e.g., pre-) configured offset.

In a second example, the WTRU may determine whether the reserved resource is available based on any of (i) the CAPC of its data, (ii) the CAPC of the data associated with the reserving resource and (iii) the relative CAPC of its data and the CAPC associated with the reserving resource.

In one example shown in FIG. 11, the WTRU may determine a resource that may be reserved by another WTRU to be unavailable if (1) the CAPC associated with the reserved resource is larger than the CAPC of its data and (2) RSSI measured in the reserving transmission in the sensing window is greater than a (e.g., pre-) configured threshold. In FIG. 11, the white slots shown at 1110 may be considered (e.g., determined) as available.

WTRU Prioritizing the Slot(s) in which to Perform LBT and Transmission

After extracting the sensing result, the WTRU may determine the set of slots to perform LBT and transmission. The WTRU may determine which resource/slot to prioritize based on any of (i) a slot that may not be reserved by any other WTRU and (ii) the earlier slot in time.

WTRU Procedure after Failing LBT to Access the Channel in a Slot for Single Channel Resource Allocation

In one embodiment, the WTRU may fail LBT to access the channel before a selected slot to perform LBT and transmission. The WTRU may then perform one or any combination of the following three options.

In a first option, the WTRU may keep the current LBT parameter (e.g., N) and may continue to perform LBT in the subsequent slot.

In a second option, the WTRU may jump (e.g., proceed) to the next pre-selected slot. For example, in one approach, the WTRU may pre-select X slots from the set of Y first-in-time slots (e.g., by random selection) to perform LBT and transmission, wherein the value of X and/or Y (e.g., any of max of X, max of Y, min of X, min of Y) may be (e.g., pre-) configured based on the QoS of the TB (e.g., any of remaining PDB, priority). In another approach, the WTRU may pre-select X slots from a sub-window (e.g., early sub-window from the resource selection window) to perform LBT and transmission, wherein the value of X and/or the size of the sub-window may be (e.g., pre-) configured based on the QoS of the TB (e.g., any of remaining PDB, priority). If the WTRU fails to access the first pre-selected slot, the WTRU may jump (e.g., proceed) to the second pre-selected slot to perform LBT and transmission. The WTRU may keep the current LBT parameter before jumping to the second pre-selected slot. The WTRU may continue the procedure until it successfully performs LBT and transmission in one of the pre-selected slots.

In a third option, the WTRU may trigger LBT failure-based resource (re) selection using the updated LBT parameters (e.g., N). For example, the WTRU may first pre-select one slot to perform LBT and transmission. If the WTRU fails to access the pre-selected slot, the WTRU may then trigger LBT failure-based resource (re) selection by determining the set of available slots to perform LBT and transmission based on the updated LBT parameters (e.g., keep the current value of N), resource selection window, and the QoS of the TB (e.g., the remaining PDB). The WTRU may then pre-select another slot to perform LBT and transmission. The WTRU may continue to perform the procedure until it successfully performs LBT and transmission in one of the pre-selected slots.

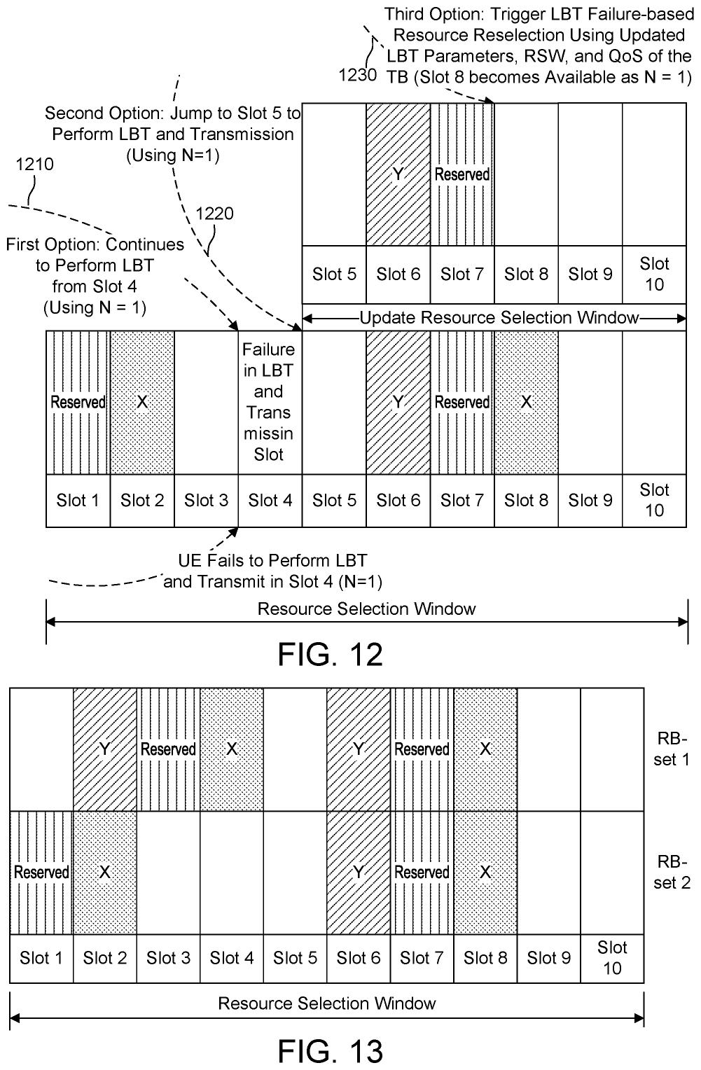

In one example shown in FIG. 12, the WTRU may first fail to perform LBT and transmission in one pre-selected slot (e.g., slot 4). In FIG. 12, the white slots may be considered as available. Before failing to perform LBT and transmission in slot 4, the WTRU may have updated N=1. In the first option 1210, the WTRU may continue to perform LBT from slot 4 until it succeeds in LBT and may transmit in a slot. In the second option 1220, the WTRU may first pre-select slot 4, slot 5, and slot 10 to perform LBT and transmission. The WTRU may jump to slot 5 to perform LBT and transmission after it failed to perform LBT and transmission in slot 4. The WTRU may use N=1 as one of the updated LBT parameter(s). If the WTRU fails LBT and transmission in slot 5, the WTRU may jump to slot 10 to perform LBT and transmission. In the third option 1230, the WTRU may trigger LBT failure-based resource reselection, in which the WTRU may update the availability of each resource. For example, the WTRU may determine X=0 in this resource (re-) selection procedure. The WTRU may determine that slot 8, which was not available, may be available in the new resource (re) selection procedure. The WTRU may select one of the slots to perform LBT and transmission. The WTRU may use N=1 as one of the updated LBT parameter(s).

WTRU Determining which Slots May be Available to Perform LBT and Transmission for Wideband Operation

For wideband operation, the WTRU may be (e.g., pre-) configured to select a resource with at least M RB-sets contiguously available (M being an integer value). The WTRU may determine to select an available slot. In one embodiment, the WTRU may consider (e.g., determine) a slot having at least M contiguously available RB-sets as an available slot. In another approach, the WTRU may consider (e.g., determine) a slot having at least M contiguously available RB-sets including the primary RB-set as an available slot. For example, as shown in FIG. 13, the WTRU may consider (e.g., determine) the slots having two RB-sets available to be available. Specifically, the WTRU may consider (e.g., determine) slot 5, 9, and 10 to be available slots.

### WTRU Prioritizing to Perform LBT and Transmission in a Slot for Wideband Transmission

After extracting the sensing result, the WTRU may determine the set of slots in which to perform LBT and transmission. The WTRU may determine which resource/slot to prioritize based on one or any combination of the following:
The slot having at least a (e.g., pre-) configured number of (e.g., contiguous) RB-sets considered as available.
The slot having at least a (e.g., pre-) configured number of (e.g., contiguous) RB-sets including the primary RB-set considered as available.
A slot that may not be reserved by any other WTRU.
The earliest in time slot.
   WTRU Determining in which Slot to Perform LBT and Transmission for Wideband Transmission

The WTRU may determine in which slot to perform LBT and transmission for wideband transmission based on the set of slots having at least M (e.g., pre-) configured contiguous available RB-sets. In one embodiment, the WTRU may select a (e.g., certain) number of slots (e.g., X % of slots) in a sub-window (e.g., the earliest sub-window in the resource selection window). The WTRU may (e.g., randomly) select one slot in that window in which to perform LBT and transmission. In another approach, the WTRU may select a (e.g., certain) number of first-in-time available slots (e.g., X slots). The WTRU may then (e.g., randomly) select one of the X slots in which to perform LBT and transmission.

WTRU Procedure after Failing LBT to Access the Channel in a Slot for Multi-Channel Resource Allocation

In one embodiment, the WTRU may fail LBT to access the channel before a selected slot to perform LBT and transmission for wideband transmission. The WTRU may then perform one or any combination of the following three options.

In a first option, the WTRU may continue to perform LBT in the subsequent available slot. In one approach, the WTRU may keep the same primary RB-set to perform LBT and the WTRU may keep the updated LBT parameter (e.g., N) to perform LBT. In another approach, the WTRU may change the primary RB-set and may use another set of LBT parameters to access the channel, which may be associated with the newly selected primary RB-set.

In a second option, the WTRU may jump (e.g., proceed) to the next pre-selected slot. For example, the WTRU may pre-select X slots from the set of Y first-in-time slots (e.g., by random selection) to perform LBT and transmission, in which the value of X and/or Y (e.g., any of max of X, max of Y, min of X, min of Y) may be (e.g., pre-) configured based on the QoS of the TB (e.g., any of remaining PDB, priority). In another example, the WTRU may pre-select X slots from a sub-window (e.g., early sub-window from the resource selection window) to perform LBT and transmission, in which the value of X and/or the size of the sub-window may be (e.g., pre-) configured based on the QoS of the TB (e.g., any of remaining PDB, priority). If the WTRU fails to access the first pre-selected slot, the WTRU may jump (e.g., proceed) to the second pre-selected slot to perform LBT and transmission. The WTRU may keep the current LBT parameter before jumping (e.g., proceeding) to the second pre-selected slot. The WTRU may continue the procedure until it successfully performs LBT and transmission in one of the pre-selected slots.

In a third option, the WTRU may trigger LBT failure-based resource (re) selection using the updated LBT parameters (e.g., N). For example, the WTRU may first pre-select one slot to perform LBT and transmission. If the WTRU fails to access the pre-selected slot, the WTRU may trigger LBT failure-based resource (re) selection by determining the set of available slots to perform LBT and transmission based on any of the updated LBT parameters (e.g., keep the current value of N), resource selection window, and the QoS of the TB (e.g., the remaining PDB). The WTRU may pre-select another slot to perform LBT and transmission. The WTRU may continue to perform the procedure until it successfully performs LBT and transmission in one of the pre-selected slots.

### WTRU Determining a Primary RB-Set

The WTRU may determine the primary RB-set (e.g., for Type B LBT), e.g., among a plurality of RB sets based on one or any combination of the following five examples.

In a first example, the WTRU may determine the primary RB-set based on the CBR of each RB-set (e.g., of the plurality of RB sets). For example, the WTRU may select the RB-set satisfying a condition (e.g., having the lowest CBR) as the primary RB-set. For example, the WTRU may select the RB-set having CBR smaller than a (pre-) configured threshold as the primary RB-set.

In a second example, the WTRU may determine the primary RB-set based on a channel occupancy ratio (CR) of the WTRU (e.g., satisfying a condition). For example, the WTRU may select the RB-set having the lowest CR of the WTRU as the primary RB-set.

In a third example, the WTRU may determine the primary RB-set based on the number of its reserved resources (e.g., satisfying a condition) in a window. For example, the WTRU may select the RB-set having the smallest/largest number of reserved resources in the window as the primary RB-set.

In a fourth example, the WTRU may determine the primary RB-set based on the number of transmitted resources in the past (e.g., satisfying a condition). For example, the WTRU may select the RB-set having the smallest/largest number of transmitted resources in the window as the primary RB-set.

In a fifth example, the WTRU may determine the primary RB-set based on the number of available resources/slots (e.g., satisfying a condition). For example, the WTRU may select the RB-set having the largest number of available resources/slots in a window (e.g., resource selection window) as the primary RB-set.

### WTRU Determining to Switch the Primary RB-Set

The WTRU may trigger primary RB-set (e.g., for Type B LBT) reselection based on one or any combination of the following events (e.g., conditions being satisfied):
WTRU performing resource (re) selection;
WTRU failing LBT;
WTRU continuously failing LBT for a (e.g., pre-) configured number of times;
WTRU failing to access the channel after a period of time;
CBR of the primary RB-set becoming greater than a (e.g., pre-) configured threshold; and
CBR of another RB-set becoming an (e.g., pre-) configured offset smaller than the CBR of the primary RB-set.
   WTRU Procedure after Failing LBT to Access the Channel for Singe-Channel Resource Allocation in Wideband

In one embodiment, in wideband operation, the WTRU may fail LBT to access the channel before a selected resource in one RB-set to perform single-band transmission. The WTRU may perform one or any combination of the following four options.

In a first option, the WTRU may continue to perform LBT in the subsequent available resource in the same RB-set. The WTRU may keep the updated LBT parameter (e.g., N) to perform LBT in the subsequent slot.

In a second option, the WTRU may jump to the next pre-selected resource, which may be in the same or a different RB-set compared to the first pre-selected resource. For example, the WTRU may pre-select a (e.g., certain) number of available resources in which to perform LBT and transmission. The set of pre-selected resources may be (e.g., randomly) selected from the set of available resources in a sub-window (e.g., earliest sub-window from the resource selection window) or from the set of X first-in-time resources. In one embodiment, the WTRU may keep one set of LBT parameters for all RB-sets. The WTRU may use the updated LBT parameters (e.g., N) to access the channel in the next pre-selected resource. In another embodiment, the WTRU may use independent LBT parameters for each RB-set.

In a third option, the WTRU may jump to the next pre-selected slot. For example, the WTRU may pre-select X resources from the set of Y first-in-time slots (e.g., by random selection) to perform LBT and transmission, in which the value of X and/or Y (e.g., any of max of X, max of Y, min of X, min of Y) may be (e.g., pre-) configured based on the QoS of the TB (e.g., any of remaining PDB, priority). X and Y resources may be located in all (e.g., any) RB-sets. In another example, the WTRU may pre-select X resources from a sub-window (e.g., early sub-window from the resource selection window) to perform LBT and transmission, in which the value of X and/or the size of the sub-window may be (e.g., pre-) configured based on the QoS of the TB (e.g., any of remaining PDB, priority). If the WTRU fails to access the first pre-selected resource, the WTRU may jump to the second pre-selected resource to perform LBT and transmission. In one approach, the WTRU may keep one set of LBT parameters for all RB-sets. The WTRU may use the updated LBT parameters (e.g., N) to access the channel in the next pre-selected resource. In another approach, the WTRU may keep independent LBT parameters for each RB-set.

In a fourth option, the WTRU may trigger LBT failure-based resource (re) selection using the updated LBT parameters (e.g., N). For example, the WTRU may first pre-select one resource to perform LBT and transmission. If the WTRU fails to access the pre-selected resource, the WTRU may trigger LBT failure-based resource (re) selection by determining the set of available resources to perform LBT and transmission based on any of the updated LBT parameters (e.g., keep the current value of N), resource selection window, and the QoS of the TB (e.g., the remaining PDB). The WTRU may pre-select another resource to perform LBT and transmission. The WTRU may continue to perform the procedure until it successfully performs LBT and transmission in one of the pre-selected resources.

### WTRU Determining Consistent LBT Failures

In one embodiment, the WTRU may maintain consistent (e.g., persistent, repeated) LBT failure per RB-set. In another embodiment, the WTRU may maintain consistent (e.g., persistent, repeated) LBT failure per resource pool, which may comprise one or more RB-sets. The WTRU may determine one LBT failure event (e.g., to be indicated to upper layer) based on any of (i) the WTRU failing LBT to access a preselected resource, (ii) the WTRU failing LBT to access a preselected slot, (iii) the WTRU failing LBT to transmit a TB, (iv) the WTRU not receiving HARQ ACK feedback for a TB, (v) the WTRU not receiving HARQ feedback for a transmission of a TB.

WTRU Determining which CAPC to Use to Access the Channel

In one embodiment, the WTRU may determine which CAPC to use to access the channel based on any of (i) the amount of data in each LCH and/or the amount of data associated with each CAPC, (ii) the CBR of the resource pool and (iii) the maximum amount of data that can be transmitted in each COT, which may be associated with the CAPC associated with the COT.

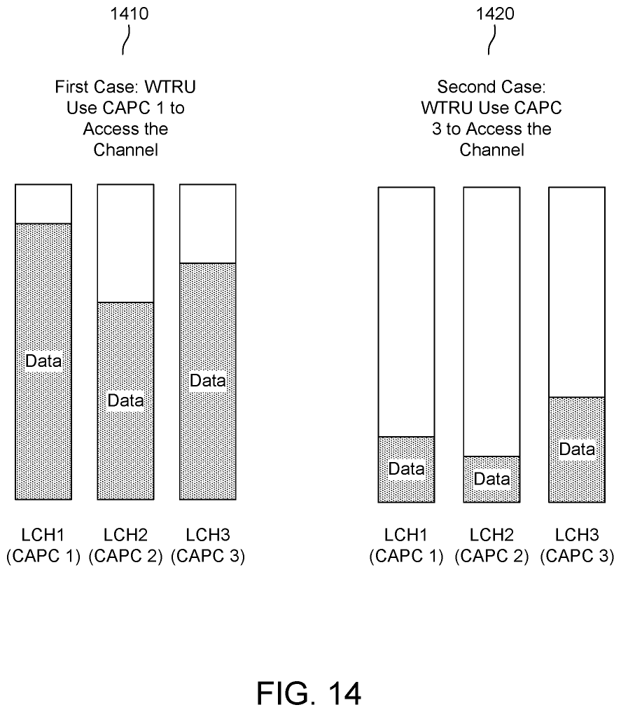

For example, as shown in FIG. 14, the WTRU may determine to use CAPC1 to access the channel for the first case of buffer status as show at 1410 and the WTRU may determine to use CAPC3 to access the channel for the second case of buffer status as shown at 1420. For example, the buffer status of LCH1 in the first case may be full, and the WTRU may use CAPC1 to transmit data in LCH1 (e.g., only). For example, the buffer status of the three LCHs in the second case may be low, and the WTRU may use CAPC3 to access the channel and transmit the whole data in one COT.

### WTRU Changing the Transmission Bandwidth in a COT Duration

In an embodiment, a WTRU upon initiating a multi-channel COT may perform wideband transmission in the set of acquired RB-sets. The WTRU may determine to change the bandwidth of its transmission by dropping one or more RB-sets and may continue to perform PSCCH/PSSCH transmission in a smaller bandwidth (e.g., a sub-set of the acquired RB-sets). The WTRU may allow other WTRUs to share a subset of the RB-set. The WTRU may indicate (e.g., transmit information) to the other WTRUs (e.g., indicating) to share the subset of RB-sets (e.g., via SCI and/or MAC CE of the PSCCH/PSSCH transmission in the COT). The WTRU may determine to reduce its transmission bandwidth based on one or any combination of the following three examples of conditions.

In a first example of condition, the WTRU may determine to reduce its transmission bandwidth based on the WTRU detecting another WTRU reserving a subset of the RB-sets in its wideband COT.

In a second example of condition, the WTRU may determine to reduce its transmission bandwidth based on the CR of the WTRU being greater than a (e.g., pre-) configured threshold.

In a third example of condition, the WTRU may determine to reduce its transmission bandwidth based on the buffer status of the WTRU being smaller than a (e.g., pre-) configured threshold. For example, if the WTRU does not have enough data to justify transmitting in wideband operation, the WTRU may reduce its transmission bandwidth for one or more remaining transmissions in the COT.

WTRU Determining in which Slot to Perform LBT and Transmission for Multi-Consecutive Slot Transmission.

In one embodiment, the WTRU may be (e.g., pre-) configured to perform resource selection for multi-consecutive slot transmission (MCSt) of N consecutive slots (N being an integer number). The WTRU may determine in which slot to start LBT and transmission based on the set of slots having at least N contiguous available slots. In one embodiment, the WTRU may select a (e.g., certain) number of slots (e.g., X % of slots) in a sub-window (e.g., the earliest sub-window in the resource selection window). The WTRU may (e.g., randomly) select one slot in that window in which to perform LBT and transmission. In another approach, the WTRU may select a certain number of first-in-time available slots (e.g., X slots). The WTRU may then (e.g., randomly) select one of the X slots in which to perform LBT and transmission.

WTRU Determining in which Slot to Perform LBT and Transmission after Transmission in One COT.

In another embodiment, the WTRU may successfully acquire a COT and perform transmission in the COT. After successfully transmitting in the COT, in one embodiment, the WTRU may determine in which slot to perform LBT and transmission after the COT based on one of the reserved slots in the previous COT. Specifically, in the current COT, the WTRU may reserve another COT in the resource selection window. The WTRU may then perform LBT and transmission in the next reserved COT. In another approach, the WTRU may trigger resource (re) selection to after it may have finished transmission in the COT.

### Methods for Network-Assisted Resource Allocation

### WTRU Requesting the Sidelink Resource

In some embodiments, the WTRU may request the sidelink resource from the network. The WTRU may implicitly/explicitly indicate one or more of the following information to the network.

In a first example, the WTRU may any of implicitly and explicitly indicate one or more LBT parameters used to access the channel in the past and/or the future transmission (e.g., the next transmission) such as any of the contention window and the initialized backoff time.

In a second example, the WTRU may any of implicitly and explicitly indicate information associated with the intended transmission of the TB, such as any of the QoS of the data, a TB size, a modulation and coding scheme (MCS), and a number of transmissions for the TB.

The WTRU may explicitly indicate any piece of information described herein by transmitting explicit information indicating that piece of information. The WTRU may implicitly indicate any piece of information described herein by transmitting another piece of information associated with that (e.g., implicitly indicated) piece of information.

WTRU Receiving Sidelink Grant from the Network

The WTRU may receive scheduling information from the network, which may include one or any combination of the following pieces of information.

In a first example, the scheduling information may indicate the resources for one or more LBT sub-bands, which may include any of the frequency and the duration of the resources in each LBT sub-band. In one approach, the WTRU may receive sidelink grant information with the fixed timing offset and duration. In another approach, the WTRU may receive sidelink grant information as a sliding window with a flexible offset and fixed duration. For example, the WTRU may receive sidelink grant information in a window of offset and a fixed duration of (e.g., four slots). The WTRU may acquire the channel for four slots regardless of when it may succeed in LBT.

In a second example, the scheduling information may indicate one or more LBT parameters used to access the channel.

In a third example, the scheduling information may indicate the transmission duration for the last transmission of the COT.

In a fourth example, the scheduling information may indicate the UL feedback resource, which may be used to report the LBT and/or transmission results. For example, the WTRU may receive downlink control information (DCI) indicating the PUSCH resource to report resource usage status of the scheduled sidelink grant. The WTRU may use any of a MAC CE and a RRC message to report the resource usage status to the network. In another example, the WTRU may receive a DCI (e.g., the same DCI scheduling sidelink resource) to indicate the physical uplink control channel (PUCCH) resource to report the resource usage status of the scheduled sidelink grant. The WTRU may use uplink control information (UCI), e.g., HARQ, to report the resource usage status of the scheduled sidelink grant.

WTRU (e.g., Triggering) Reporting UCI and/or MAC CE to the Network

The WTRU may trigger reporting (e.g., sending feedback information indicating) the results of LBT and/or transmission in the scheduled sidelink grant from the network. In one approach, the WTRU may trigger sending feedback information such as e.g., a scheduling request (SR) to the network (e.g., only). In another approach, the WTRU may trigger sending (e.g., both) UCI (e.g., SR) and MAC CE (e.g., SL buffer status report (SL BSR)) to the network.

### WTRU (e.g., Triggering) Sending UCI to the Network

In one approach, the WTRU may be (e.g., pre-) configured with a UCI resource (e.g., a dedicated SR to indicate the status of resource usage in the scheduled sidelink grant) to indicate the LBT and/or transmission status to the network regarding the scheduled sidelink resource. For example, the WTRU may be (e.g., pre-) configured with the conditions to trigger sending UCI (e.g., SR) regarding the LBT and/or transmission. The condition to trigger sending UCI (e.g., SR) may be based on one or any combination of the following four examples.

In a first example, the condition for sending UCI (e.g., SR) may be based on the number/percentage of the acquired LBT sub-bands over the scheduled LBT sub-bands. In one example, the WTRU may be scheduled with sidelink resources in two LBT sub-bands. For example, the WTRU may trigger (e.g., send) SR to the network if it fails to acquire one or both of the LBT sub-bands. In another example, the WTRU may trigger (e.g., send) SR to the network only if it fails to acquire both LBT sub-bands.

In a second example, the condition for sending UCI (e.g., SR) may be based on the number/percentage of the acquired slots over a number of scheduled slots. In one example, the WTRU may be scheduled with sidelink resources in two LBT sub-bands spanning over 4 slots. The WTRU may trigger (e.g., send) SR to the network if it fails to acquire one or two LBT sub-bands after two slots.

In a third example, the condition for sending UCI (e.g., SR) may be based on the number/percentage of the transmitted resources over the scheduled resources. In one example, the WTRU may be scheduled with sidelink resources in two LBT sub-bands spanning over 4 slots. The WTRU may trigger (e.g., send) SR to the network if it fails to acquire 50% of the total scheduled sidelink resources.

In a fourth example, the condition for sending UCI (e.g., SR) may be based on the remaining data in the buffer satisfying a further condition. For example, the WTRU may trigger UCI (e.g., SR) if the WTRU still has data having priority and/or latency meeting a threshold.

The threshold of the number/percentage of acquired LBT sub-bands, slots, and/or resources to trigger sending UCI and/or MAC CE may be any of (e.g., pre-) configured and dynamically indicated to the WTRU (e.g., via DCI).

### WTRU Triggering Sending MAC CE to the Network

In some embodiments, the WTRU may trigger sending feedback information such as e.g., a MAC CE (e.g., SL-BSR) and/or RRC message (e.g., WTRUAssistantInformation) to indicate the resource usage status (e.g., any of LBT and transmission status, the buffer status of the WTRU) after the scheduled sidelink resources. The gNB may then be aware of the amount of data that the WTRU may have transmitted in (e.g., based on) the scheduled grant. The WTRU may be (e.g., pre-) configured with one or more conditions to trigger sending a MAC CE and/or RRC message to send such indication. The condition may be based on one or any combination of the following three examples.

In a first example, the condition for sending feedback information (e.g., SL-BSR) indicating the resource usage status may be based on the remaining buffer of the WTRU and/or the remaining buffer of the WTRU having a QoS satisfying a condition. For example, the WTRU may trigger sending a MAC CE (e.g., SL BSR) if the WTRU still has data having priority and/or latency meeting a threshold.

In a second example, the condition for sending feedback information (e.g., SL-BSR) indicating the resource usage status may be based on the amount/percentage of transmission and/or the amount/percentage of the resource/LBT sub-bands used in the scheduled sidelink grant.

In a third example, the condition for sending feedback information (e.g., SL-BSR) indicating the resource usage status may be based on whether SR may have been sent. For example, the WTRU may trigger sending a MAC CE (e.g., SL BSR) if the SR associated with the resource usage status of the scheduled sidelink grant is sent.

### WTRU Sending HARQ Feedback to Report the Resource Usage

In one approach, the WTRU may send feedback information such as e.g., one-bit HARQ feedback in PUCCH to report the transmission status of the scheduled sidelink grant. In another approach, the WTRU may send a HARQ codebook to send multi-bit HARQ feedback in PUCCH. In the codebook, the WTRU may use one bit to report the status of one scheduled LBT sub-band. The number of bits in the HARQ codebook for one scheduling may be a function of the number of LBT sub-bands (e.g., pre-) configured in the resource pool. In case the WTRU sends one-bit HARQ feedback, the WTRU may determine whether to send ACK or NACK based on any of (i) the number/percentage of the acquired LBT sub-bands over the scheduled LBT sub-bands, (ii) the number/percentage of the acquired slots over the number of scheduled slots, and (iii) the number/percentage of the transmitted resources over the scheduled resources.

For example, the WTRU may send (e.g., positive) ACK feedback if the number/percentage of acquired LBT sub-bands, slots, and/or resources is greater than or equal to a threshold. Otherwise, the WTRU may send (e.g., negative) NACK feedback. The threshold of the number/percentage of acquired LBT sub-bands, slots, and/or resources to feedback ACK/NACK may be any of pre-configured and dynamically indicated to the WTRU (e.g., via DCI).

In case the WTRU sends a HARQ codebook of N bits of information, one bit may be associated with one scheduled LBT sub-band. The WTRU may determine whether to send ACK or NACK for each LBT sub-band based on any of (i) the number/percentage of the acquired slots over the number of scheduled slots in each LBT sub-band and (ii) the number/percentage of the transmitted resources over the scheduled resources in each LBT sub-band.

For example, the WTRU may send (e.g., positive) ACK feedback if the number/percentage of the acquired slots, and/or resources in each LBT sub-band is greater than or equal to a threshold. Otherwise, the WTRU may send (e.g., negative) NACK feedback for each LBT sub-band. The threshold of the number/percentage of acquired LBT sub-bands, slots, and/or resources to feedback ACK/NACK may be any of (e.g., pre-) configured and dynamically indicated to the WTRU (e.g., via DCI).

The WTRU may be configured to trigger sending UCI (e.g., indicating a SR) and/or a MAC CE (e.g., indicating a SL-BSR) to the network based on whether PUCCH is available in the sidelink scheduling DCI. For example, if PUCCH used to report HARQ status (e.g., ACK/NACK) is not included in the sidelink scheduling DCI (e.g., DCI format 3_0), the WTRU may trigger sending UCI and/or MAC CE in a case where the number (e.g., or percentage) of the acquired slots and/or resources satisfies a condition (e.g., is smaller than the (e.g., pre-) configured threshold). Otherwise, if the sidelink scheduling DCI includes (e.g., indicates) PUCCH resource to report HARQ status, the WTRU may not trigger sending UCI and/or MAC CE e.g., regardless of LBT status in sidelink.

Embodiments are described herein with the example of a ratio between a subset of acquired (e.g., transmitted) resources over a set of scheduled resources. Embodiments described herein are not limited to a ratio and are compatible with any function of acquired (e.g., transmitted) resources and scheduled resources for transmitting feedback information (e.g., including any of HARQ ACK, HARQ NACK, SR, and SL-BSR).

### Methods for Guard-Band Usage

### WTRU Determining its Transmission Scheme in One LBT Sub-Band

The WTRU may acquire one LBT sub-band. The WTRU may perform one or any combination of the following three examples of transmission schemes in one LBT sub-band.

In a first example of transmission scheme, the WTRU may not use the guard-band.

In a second example of transmission scheme, the WTRU may use one portion of the guard-band in one transmission of a TB (e.g., one haft of the guard-band).

In a third example of transmission scheme, the WTRU may use the whole guard-band between two contiguous LBT sub-bands.

### WTRU Determining its Transmission Scheme in Multiple Contiguous LBT Sub-Bands

The WTRU may acquire two contiguous LBT sub-bands. The WTRU may perform one or any combination of the following transmission schemes regarding guard-band usage.

In one transmission scheme, the WTRU may perform two transmissions of the same TB, in which each transmission may be within its LBT sub-band, and guard-band resource may not be used by any transmission.

In another transmission scheme, the WTRU may perform two transmissions of the same TB, in which each transmission may be within its LBT sub-band, wherein one of the two transmissions may occupy the whole or a portion of the guard-band and the other transmission may not use the guard-band.

In another transmission scheme, the WTRU may perform two transmissions of the same TB, in which each transmission may be within its LBT sub-band, and each transmission may occupy one portion (e.g., a half) of the guard-band.

In another transmission scheme, the WTRU may perform one transmission of the TB spanning over the two LBT sub-bands. In some embodiments, the WTRU may not use the guard-band. In other embodiments, the WTRU may use a portion of the LBT sub-band. In yet other embodiments, the WTRU may use the whole guard-band.

In another transmission scheme, the WTRU may perform two transmissions of different TBs, in which each transmission may be within its LBT sub-band and guard-band resources may not be used by any transmission.

In another transmission scheme, the WTRU may perform two transmissions of different TBs, in which each transmission may be within its LBT sub-band. One of the two transmissions may occupy the whole or a portion of the guard-band, and the other transmission may not use the guard-band.

In another transmission scheme, the WTRU may perform two transmissions of different TBs, in which each transmission may be within its LBT sub-band and each transmission may occupy one portion (e.g., a half) of the guard-band.

### WTRU Indicating the Transmission Scheme and Guard-Band Usage for One or More LBT Sub-Bands

The WTRU may indicate (e.g., transmit information) to another node (e.g., receiver WTRU(s)) (e.g., indicating) its transmission scheme and/or guard-band usage in one and/or multiple LBT sub-bands. In one approach, the indication may be conveyed (e.g., included) in the SCI associated with one or more transmissions. In another approach, the indication may be conveyed (e.g., transmitted) using a higher layer message, such as e.g., any of NAS, PC5 RRC, and MAC CE. For example, the WTRU may use one or more SCIs (e.g., second stage SCI) associated with one or more transmissions of one or more TBs to indicate the transmission scheme and/or guard-band usage of one or more TBs in the slot. For example, the WTRU may transmit information indicating one or any combination of the following two examples.

In a first example, the WTRU may transmit information indicating whether the WTRU uses the slot to transmit one or multiple TBs. For example, the information may indicate for one TB transmitted in the slot, whether the TB spans over multiple LBT sub-bands or each transmission is within one LBT sub-band.

In a second example, the WTRU may transmit information indicating whether guard-band is used in the slot and/or whether the transmission uses the guard-band and/or the bandwidth usage of the guard-band (e.g., a full guard-band, or a portion of the guard-band).

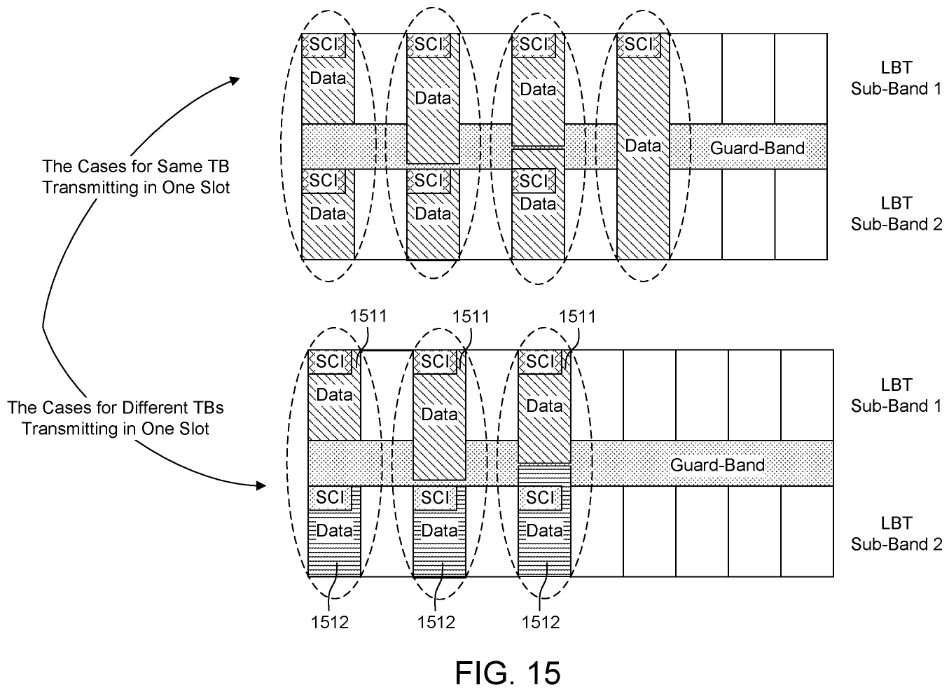

In one example shown in FIG. 15, the WTRU may perform one of the four transmission schemes and guard-band usage for one TB transmitted simultaneously in two contiguous sub-bands and one of the three transmission schemes and guard-band usage for two TB transmitting in the same slot, in which one TB may be associated with the transmission in the slant hatched rectangle shown at 1511 and the other TB may be associated with the transmission in the horizontally hatched rectangle shown at 1512.

### WTRU Determining Whether to Use a Guard-Band for its Transmission

In some embodiments, the WTRU may acquire two or more contiguous LBT sub-bands. The WTRU may determine the transmission scheme. The WTRU may determine whether to use the guard-band and/or the bandwidth of the guard-band to use for each transmission between two LBT sub-bands. The transmission scheme and the guard-band usage may be determined based on one or any combination of the following four examples.

In a first example, the transmission scheme and the guard-band usage may be determined based on a (e.g., pre-) configuration in the resource pool. For example, the WTRU may be (e.g., pre-) configured in the resource pool whether to use the guard-band between two contiguous LBT sub-bands. The WTRU may follow the (pre-) configuration in the resource pool.

In a second example, the transmission scheme and the guard-band usage may be determined based on an indication from the network. For example, the WTRU may receive wideband sidelink grant from the network. The WTRU may receive an indication from the network as to which transmission scheme to use and/or whether to use the guard-band. The WTRU may determine the transmission scheme and the guard-band usage based on the indication from the network.

In a third example, the transmission scheme and the guard-band usage may be determined based on whether the WTRU initiated the COT or shares the COT with other WTRUs. For example, the WTRU may determine not to use the guard-band if it shares the COT with another WTRU. For example, the WTRU may use one transmission scheme in which each transmission may be within the LBT sub-band, if it shares the COT with another WTRU.

In a fourth example, the transmission scheme and the guard-band usage may be determined based on the order of the transmission in the COT (e.g., whether the WTRU transmits the first one or several TBs in the COT or transmits the last several TBs in the COT). For example, the WTRU may use one transmission scheme (e.g., each transmission may be within the LBT sub-band) for the first N slots and/or M TBs of the COT. For example, the WTRU may use another transmission scheme (e.g., one transmission of the TB spanning over multiple LBT sub-bands) for the transmissions after the first N slots and/or after the first M TBs. M may be fixed to be one TB and N may be (e.g., pre-) configured and/or determined based on the processing capability of the WTRU. In another example, the WTRU may not use the guard-band for the first N slots and/or M TBs of the COT. Alternatively, the WTRU may use the guard-band for the slots after the first N slots and/or M TBs. M may be fixed to be one TB and N may be (e.g., pre-) configured and/or determined based on the processing capability of the WTRU.

### WTRU Determining Whether to Use the Guard-Band Based on the Transmission Scheme

The WTRU may determine whether to use the guard-band and/or the bandwidth of the guard-band to use for transmission based on the transmission scheme of the WTRU. For example, the WTRU may use the guard-band if one transmission of the TB spans over two LBT sub-bands. Alternatively, the WTRU may not use the guard-band if each transmission of the TB is within one LBT bandwidth. For example, the WTRU may not use the guard-band if the WTRU performs transmission of different TBs in the slot.

### Methods for SCI Decoding Reduction

WTRU Determining which RB-Set to Decode SCI

In one embodiment, the WTRU may determine which RB-sets to decode SCI and/or which RB-sets to prioritize SCI decoding based on any of (i) an indication received from another network element (such as e.g., another WTRU, a peer WTRU of unicast session, a gNB, etc.), (ii) a RSSI measurement and a SCI decoding status, and (iii) a (e.g., pre-) configured priority of (e.g., each) RB-set.

In a first example, the WTRU may determine which RB-sets to decode SCI and/or which RB-sets to prioritize SCI decoding based on an indication that may be received from another network element (e.g., another WTRU, a peer WTRU of unicast session, a gNB, etc.). In one example, the WTRU may be (e.g., pre-) configured with one (e.g., default) RB-set to perform broadcast communication. The WTRU may establish a unicast session with another WTRU. The other WTRU may send information to the WTRU indicating a request to communicate in another set of RB-sets. The WTRU may perform sensing and decoding SCI in the indicated set of RB-sets by the peer WTRU. In another example, another WTRU may indicate (e.g., send information indicating) a congestion level associated with transmission activity of other technologies (e.g., Wi-Fi), in one RB-set. The WTRU may stop decoding SCI in that RB-set if the indicated congestion level (e.g., CBR) satisfies a condition (e.g., is greater than a (e.g., pre-) configured threshold). The WTRU may resume decoding SCI if the indicated congestion level (e.g., CBR) fails to satisfy the condition (e.g., is smaller than the (e.g., pre-) configured threshold). In another example, the WTRU may determine its SCI decoding behavior in one RB-set based on the indication that may be received from another WTRU. For example, if CBR (e.g., associated with transmission activity of other technologies) satisfies a condition (e.g., is larger than a (e.g., pre-) configured) threshold, the WTRU may reduce its SCI decoding periodicity (e.g., the WTRU may decode SCI every N slots, N being an integer). Otherwise (e.g., if the CBR is smaller than the threshold), the WTRU may decode SCI, for example, every slot/mini slot.

In a second example, the WTRU may determine which RB-sets to decode SCI and/or which RB-sets to prioritize SCI decoding based on any of a RSSI measurement and a SCI decoding status. For example, if a RSSI measured in a period satisfies a first condition (e.g., is larger than a (e.g., pre-) configured threshold) and if the number of decoded SCI within a period satisfies a second condition (e.g., is smaller than a (e.g., pre-) configured) threshold, the WTRU may reduce SCI decoding periodicity.

In a third example, the WTRU may determine which RB-sets to decode SCI and/or which RB-sets to prioritize SCI decoding based on a (e.g., pre-) configured priority of (e.g., each) RB-set. For example, the WTRU may be (e.g., pre-) configured with the priority decoding for (e.g., each) RB-set. The WTRU may sequentially prioritize which RB-set to decode SCI based on the associated priority of the SCI decoding for the (e.g., each) RB-set.

### Tx WTRU Determining the Number of Symbols for Automatic Gain Control (AGC) Purpose

In one embodiment, for a transmission in a first starting symbol of a slot with multiple starting symbols, WTRU may determine whether to use one or two symbols for automatic gain control (AGC) based on the number of RB-set(s) configured in the resource pool and the bandwidth of the transmission.

For example, the WTRU may be (e.g., pre-) configured with multiple starting symbols for a PSCCH/PSSCH transmission. The WTRU may determine the number of symbols for AGC purpose if it transmits from the first symbol of the slot. The WTRU may indicate (e.g., in the SCI) the number of AGC symbols for its PSCCH/PSSCH transmission, which may be used to support the Rx WTRU in decoding the transmission. For example, if the WTRU uses one symbol for AGC, the WTRU may repeat the same bits for the subsequent symbol. In one approach, the Tx WTRU may determine the number of symbols for AGC purpose. In another approach, the Rx WTRU may determine the number of AGC symbols to monitor. The number of symbols for AGC may be determined based on any of (i) a number of RB-sets (e.g., pre-) configured in the resource pool, (ii) whether the PSCCH/PSSCH transmission spans over the resource pool, and (iii) whether FDM is allowed for a transmission starting from a middle of the slot (e.g., not starting from the beginning of the slot).

In a first example, the WTRU may determine the number of symbols for AGC based on the number of RB-sets (e.g., pre-) configured in the resource pool. For example, if one RB-set is (e.g., pre-) configured in the resource pool, the WTRU may include (or monitor) one symbol for AGC purpose. If multiple (e.g., more than one) RB-sets are (e.g., pre-) configured in the resource pool, the number of AGC symbols may be equal to the (e.g., pre-) configured number of starting symbols in the slot.

In a second example, the WTRU may determine the number of symbols based on whether the PSCCH/PSSCH transmission spans over the (e.g., entire) resource pool. For example, if the PSCCH/PSSCH transmission spans over the (e.g., entire) resource pool, the WTRU may include (or monitor) one AGC symbol. Otherwise, (e.g., if the PSCCH/PSSCH transmission does not span over the (e.g., entire) resource pool (e.g., if the PSCCH/PSSCH transmission is localized in a set of contiguous resources of the resource pool)), the WTRU may include (or monitor) multiple (e.g., more than one) AGC symbols (e.g., the number of for AGC symbols may be equal to the (e.g., pre-) configured number of starting symbols in the slot).

In a third example, the WTRU may determine the number of symbols for AGC based on whether FDM is allowed for a transmission starting from a middle of the slot (e.g., not starting from the beginning of the slot). For example, the WTRU may include (or monitor) one AGC symbol if FDM for a transmission starting from a middle of the slot is not allowed. Otherwise, the WTRU may include (or monitor) multiple (e.g., more than one) AGC symbols (e.g., the number of symbols for AGC purpose may be equal to the (e.g., pre-) configured number of starting symbols in the slot).

### Example of WTRU Performing LBT Sub-Band Reselection

In one embodiment, the WTRU may determine whether to keep the current LBT sub-band or reselect another LBT sub-band to perform LBT (e.g., type 1 LBT for multi-channel access) and/or transmission based on a condition (e.g., CWₚ smaller a threshold, number of available slots for LBT in the resource selection window (RSW) is larger than a threshold). If the condition to switch to another LBT sub-band is satisfied, the WTRU may switch to the LBT sub-band satisfying the condition (e.g., any of the LBT sub-band having the highest number of available slots, the LBT sub-band having the lowest CWₚ). More specifically, the WTRU may perform the following steps for the LBT sub-band reselection procedure.

In a first step, the WTRU may be (e.g., pre-) configured with one or more condition (e.g., parameters) to reselect LBT sub-band to perform LBT and/or transmission. The one or more condition (e.g., parameters) may include any of a contention window threshold, an initialized backoff threshold and a threshold of the number of available slots in the RSW.

In a second step, the WTRU may be (e.g., pre-) configured with one or more conditions for selecting another LBT sub-band. The one or more conditions may include any of the LBT sub-band having the highest number of available slots and the LBT sub-band having the lowest CWₚ.

In a third step, e.g., when the TB arrives, the WTRU may determine whether the LBT sub-band reselection condition is satisfied.

In a fourth step, if the LBT sub-band reselection condition is not satisfied, the WTRU may perform LBT and/or transmission in the current LBT sub-band. Otherwise, the WTRU may determine the LBT sub-band satisfying the LBT sub-band reselection and may perform LBT and/or transmission in the determined LBT sub-band.

Example of WTRU Reporting the LBT and/or Transmission Status of the Scheduled Wideband Resource

In one embodiment, the WTRU may receive sidelink grant in multiple LBT sub-bands. The WTRU may perform (e.g., simultaneous) initial and blind retransmissions for a TB in the set of acquired LBT sub-bands in a slot and may indicate such transmission scheme in the SCI. The WTRU may determine whether to report ACK/NACK to the network based on the number of the acquired LBT sub-bands and/or the number of transmissions made in the scheduled grant. For example, the WTRU may perform the following procedure for mode 1 resource allocation in wideband sidelink unlicensed spectrum.

In a first step, the WTRU may (e.g., pre-) configured with a percentage of the acquired LTB sub-bands for one bit ACK/NACK feedback of the scheduled wideband resource.

In a second step, the WTRU may receive sidelink grant information for transmission spanning over multiple LBT sub-bands and the UL resource to use to feedback (e.g., one-bit feedback) the scheduled resource usage.

In a third step, the WTRU may perform LBT in the set of scheduled LBT sub-bands and may acquire a subset of LBT sub-bands for which LBT was successful (e.g., the sub-bands were determined as clear).

In a fourth step, the WTRU may perform (e.g., simultaneous) initial transmission and blind retransmissions in the set of acquired LBT sub-bands and may indicate in the SCI the set of (e.g., simultaneous) transmission LBT sub-bands.

In a fifth step, the WTRU may determine whether to report ACK or NACK to the network based on the number of acquired LBT sub-bands.

### Example of Guard-Band Usage

In an embodiment, the WTRU may determine whether to use a guard-band for wideband operation if it acquires two contiguous LBT sub-bands associated with the guard-band based on the transmission scheme of the TB (e.g., whether the TB spans over multiple LBT sub-bands or whether each transmission of the TB is within one LBT sub-band) and the transmission slots in the COT. The WTRU may indicate (e.g., in the SCI) its transmission scheme and whether a guard-band is used. For, example, the WTRU may perform the following steps.

In a first step, the WTRU may determine the set of LBT sub-bands to perform LBT and (e.g., potential) transmission.

In a second step, the WTRU may perform LBT in the set of LBT sub-bands and may acquire a subset of LBT sub-bands.

In a third step, for each slot in the acquired COT, the WTRU may determine one of the following transmission schemes: (i) each transmission of the TB may span over the acquired LBT sub-bands, (ii) or each transmission of the TB may be within one LBT sub-band.

In a fourth step, the WTRU may determine whether to use any guard-band within the set of LBT sub-bands based on (1) whether it acquires two contiguous LBT sub-bands, (2) the selected transmission scheme, and (3) the slots in which it may perform transmission in the COT. For example, the WTRU may use the guard-band if it performs transmission of the TB spanning over the acquired contiguous LBT sub-bands. Otherwise, it may not use the guard-band.

In a fifth step, the WTRU may perform transmission in the acquired subset of LBT sub-bands and may indicate its transmission scheme and whether the guard-band may be used (e.g., in SCI).

### Example Method for Reselecting a LBT Sub-Band

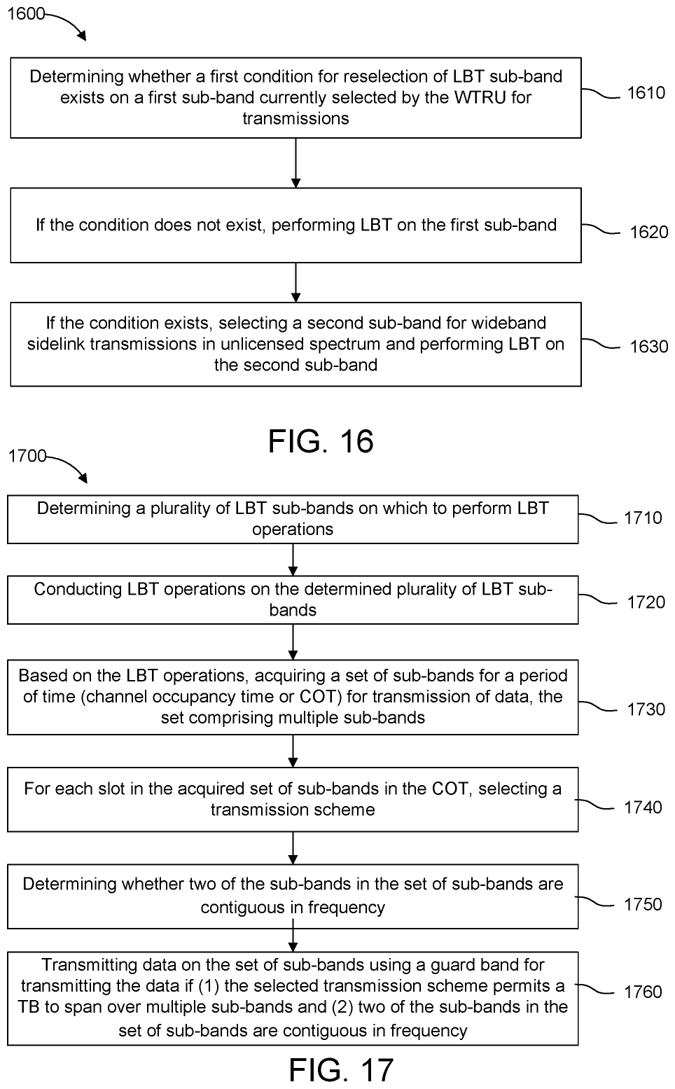

FIG. 16 is a diagram illustrating an example method 1600 for reselecting a LBT sub-band to use for wideband sidelink transmissions in unlicensed spectrum. The method 1600 may be implemented in a WTRU. As shown at 1610, the WTRU may determine whether a first condition for reselection of LBT sub-band exists on a first sub-band currently selected by the WTRU for transmissions. As shown at 1620, if the condition does not exist, the WTRU may perform LBT on the first sub-band. As shown at 1630, if the condition exists, the WTRU may select a second sub-band for wideband sidelink transmissions in unlicensed spectrum and the WTRU may perform LBT on the second sub-band.

In various embodiments, the first condition may be a size of a contention window ((′Wp) on the first sub-band meeting a threshold.

In various embodiments, selecting a second sub-band for wideband sidelink transmissions in unlicensed spectrum may comprise selecting a sub-band having the highest number of available slots.

In various embodiments, selecting a second sub-band for wideband sidelink transmissions in unlicensed spectrum may comprise selecting a sub-band having the lowest (′Wp.

In various embodiments, the WTRU may comprise a processor, a receiver, a transmitter, and memory implementing the method 1600.

### Example Method for Wideband Sidelink Transmissions in Unlicensed Spectrum

FIG. 17 is a diagram illustrating an example method 1700 for wideband sidelink transmissions in unlicensed spectrum. The method 1700 may be implemented in a WTRU. As shown at 1710, the WTRU may determine a plurality of LBT sub-bands on which to perform LBT operations. As shown at 1720, the WTRU may conduct (e.g., perform) LBT operations on the determined plurality of LBT sub-bands. As shown at 1730, based on the LBT operations, the WTRU may acquire a set of sub-bands for a period of time (e.g., channel occupancy time or COT) for transmission of data, the set comprising multiple sub-bands. As shown at 1740, for each slot in the acquired set of sub-bands in the COT, the WTRU may select a transmission scheme. As shown at 1750, the WTRU may determine whether two of the sub-bands in the set of sub-bands are contiguous in frequency. As shown at 1760, the WTRU may transmit data on the set of sub-bands using a guard band for transmitting the data if (1) the selected transmission scheme permits a TB to span over multiple sub-bands and (2) two of the sub-bands in the set of sub-bands are contiguous in frequency.

In various embodiments, the selected transmission scheme may be one of (1) a scheme wherein each transmission of a TB may span over the set of sub-bands and (2) a scheme wherein each transmission of a TB may be limited to one sub-band.

In various embodiments, the WTRU may transmit an indication to the network of the selected transmission scheme.

In various embodiments, the WTRU may transmit an indication to the network of whether or not a guard band is being used to transmit data.

In various embodiments, the WTRU may comprise a processor, a receiver, a transmitter, and memory implementing the method 1700.

### Example Method for Selecting Resources for Performing LBT

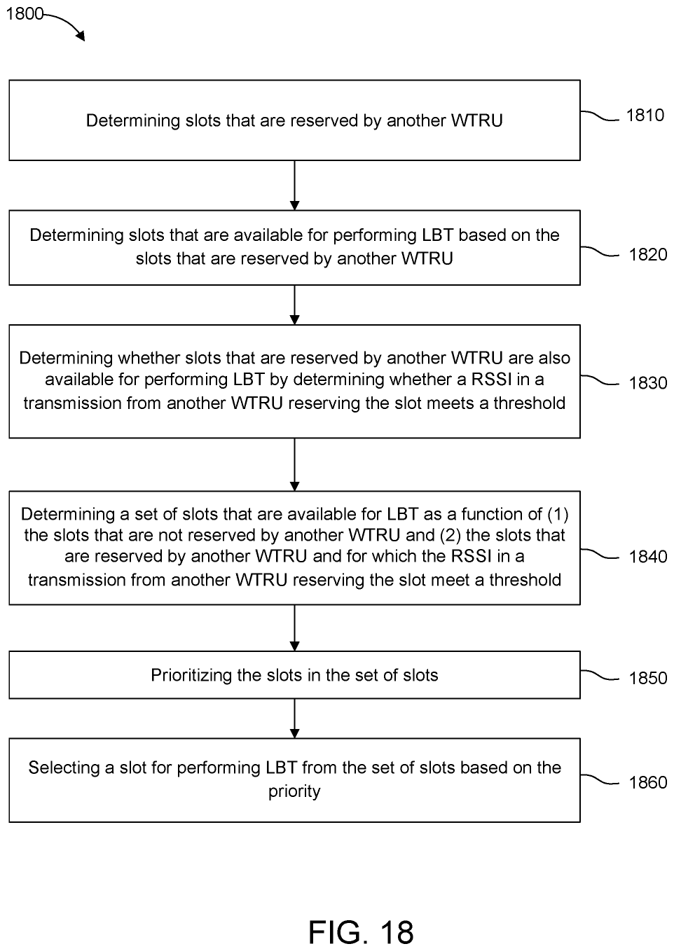

FIG. 18 is a diagram illustrating an example method 1800 for selecting resources for performing LBT to use for wideband sidelink transmissions in unlicensed spectrum. The method 1800 may be implemented in a WTRU. As shown at 1810, the WTRU may determine slots that may be reserved by another WTRU. As shown at 1820, the WTRU may determine slots that may be available for performing LBT based on the slots that may be reserved by another WTRU. As shown at 1830, the WTRU may determine whether slots that may be reserved by another WTRU are also available for performing LBT by determining whether a received RSSI in a transmission from another WTRU reserving the slot meets a threshold. As shown at 1840, the WTRU may determine a set of slots that may be available for LBT as a function of (1) the slots that may not be reserved by another WTRU and (2) the slots that may be reserved by another WTRU and for which the RSSI in a transmission from another WTRU reserving the slot may meet a threshold. As shown at 1850, the WTRU may prioritize the slots in the set of slots. As shown at 1860, the WTRU may select a slot for performing LBT from the set of slots based on the priority.

In various embodiments, determining the set of slots that may be available for performing LBT may comprise: (1) determining any slot that may be within X slots after a slot determined to be reserved by another WTRU and corresponding to a RSSI failing to meet the threshold as unavailable for performing LBT, where X may be an integer, and (2) determining any slot that may be within Y slots before a slot determined to be reserved by another WTRU and corresponding to a RSSI failing to meet the threshold as unavailable for performing LBT, where Y may be an integer.

In various embodiments, prioritizing may comprise assigning higher priority to slots that may not be reserved by another WTRU over slots that may be reserved by another WTRU.

In various embodiments, prioritizing may comprise assigning higher priority to slots that may be earlier in time over slots that may be later in time.

In various embodiments, determining the set of slots available for LBT may be further based on a CAPC of slots determined to be reserved by another WTRU.

In various embodiments, determining the set of slots available for LBT may comprise comparing the CAPC of data in slots determined to be reserved by another WTRU to the CAPC of transmission data at the WTRU.

In various embodiments, the WTRU may comprise a processor, a receiver, a transmitter, and memory implementing the method 1800.

### Example Method for Reporting Feedback Information to the Network Related to SL Transmissions

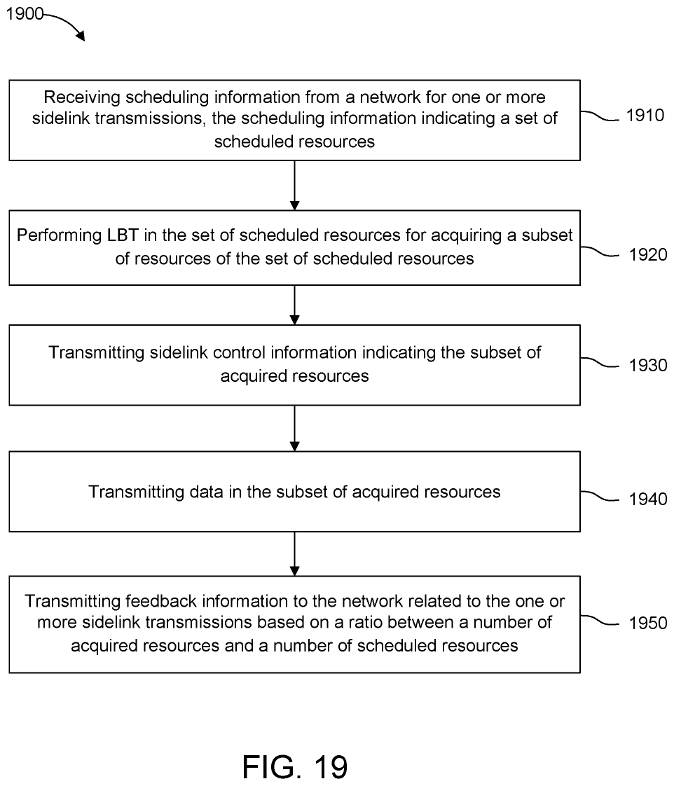

FIG. 19 is a diagram illustrating an example method 1900 for reporting feedback information to the network related to SL transmissions. The method 1900 may be implemented in a WTRU. As shown at 1910, the WTRU may receive scheduling information from a network for one or more sidelink transmissions, the scheduling information indicating a set of scheduled resources. As shown at 1920, the WTRU may perform LBT in the set of scheduled resources for acquiring a subset of resources of the set of scheduled resources. As shown at 1930, the WTRU may transmit sidelink control information indicating the subset of acquired resources. As shown at 1940, the WTRU may transmit data in the subset of acquired resources. As shown at 1950, the WTRU may transmit feedback information to the network related to the one or more sidelink transmissions based on (e.g., a ratio between) a number of acquired resources and a number of scheduled resources.

In various embodiments, a sidelink transmission of the one or more sidelink transmissions may comprise a sidelink control information transmission and a data transmission.

In various embodiments, the number of acquired resources may be the number of resources in the subset of acquired resources.

In various embodiments, the number of scheduled resources may be the number of resources in the set of scheduled resources.

In various embodiments, the set of scheduled resources may span over any of more than one LBT sub-band and more than one slot.

In various embodiments, the subset of acquired resources may span over more than one LBT sub-band.

In various embodiments, the WTRU may determine whether a condition associated with the number of acquired resources and the number of scheduled resources is satisfied.

In various embodiments, the condition may be satisfied in a case where the ratio between the number of acquired resources and the number of scheduled resources is above a threshold.

In various embodiments, the threshold may be any of pre-configured in the WTRU and dynamically indicated in downlink control information.

In various embodiments, if it is determined that the condition associated with the number of acquired resources and the number of scheduled resources is satisfied, the feedback information may indicate a positive acknowledge.

In various embodiments, the positive acknowledge may comprise a positive HARQ feedback (such as an HARQ ACK).

In various embodiments, if it is determined that the condition associated with the number of acquired resources and the number of scheduled resources is not satisfied, the feedback information may indicate any of a negative acknowledge and a request for more resources.

In various embodiments, the request for more resources may comprise any of a scheduling request (SR) and a sidelink buffer status report (SL BSR).

In various embodiments, the negative acknowledge may comprise a negative HARQ feedback (such as e.g., an HARQ NACK).

In various embodiments, the WTRU may receive configuration information indicating the condition associated with the number of acquired resources and the number of scheduled resources.

In various embodiments, the WTRU may comprise circuitry including a processor, a receiver, a transmitter, and memory configured to carry out the method 1900.

### Example Method for Determining Whether to Keep a Current LBT Sub-Band or to Select Another LBT Sub-Band

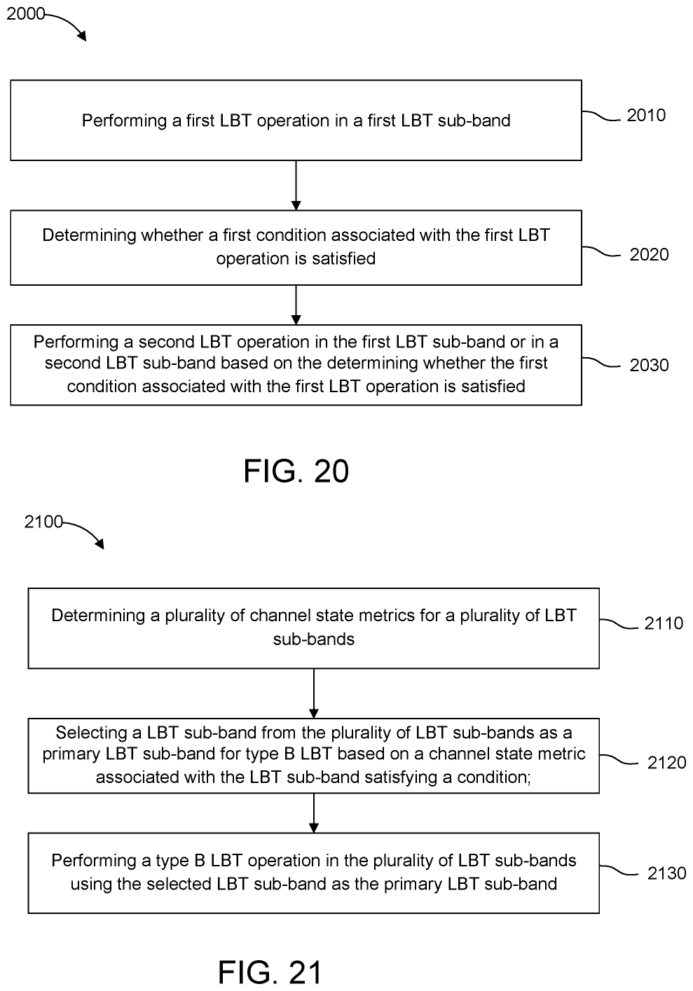

FIG. 20 is a diagram illustrating an example method 2000 for determining whether to keep a current LBT sub-band or to select another LBT sub-band. The method 2000 may be implemented in a WTRU. As shown at 2010, the WTRU may perform a first LBT operation in a first sub-band. As shown at 2020, the WTRU may determine whether a first condition associated with the first LBT operation is satisfied. As shown at 2030, the WTRU may perform a second LBT operation in the first sub-band or in a second sub-band based on the determining whether the first condition associated with the first LBT operation is satisfied.

In various embodiments, if it determined that the first condition associated with the first LBT operation is satisfied, the second LBT operation may be performed in the first sub-band.

In various embodiments, if it determined that the first condition associated with the first LBT operation is not satisfied, the second LBT operation may be performed in the second sub-band.

In various embodiments, the first condition associated with the first LBT operation may be satisfied in a case where a first contention window value associated with the first LBT operation is smaller than a first threshold.

In various embodiments, the first condition associated with the first LBT operation may be satisfied in a case where an initialized backoff value associated with the first LBT operation is smaller than a second threshold.

In various embodiments, the first condition associated with the first LBT operation may be satisfied in a case where a number of available slots in a first resource selection window associated with the first LBT operation is larger than a third threshold.

In various embodiments, the second sub-band may be selected such that the second sub-band may satisfy a second condition.

In various embodiments, the second sub-band may satisfy the second condition in a case where a second contention window value associated with the second sub-band is smaller than a first contention window value associated with the first sub-band.

In various embodiments, the second sub-band may satisfy the second condition in a case where the second sub-band is associated with a smallest contention window value in a plurality of contention window values.

In various embodiments, the second sub-band may satisfy the second condition in a case where a number of available slots in a second resource selection window associated with the second sub-band is larger than a number of available slots in a first resource selection window associated with the first sub-band.

In various embodiments, the second sub-band may satisfy the second condition in a case where the second sub-band is associated with a largest number of available slots in a resource selection window among a plurality of resource selection windows.

In various embodiments, the first condition and associated first parameters may be preconfigured in the WTRU.

In various embodiments, the WTRU may receive configuration information indicating the first condition and associated first parameters.

In various embodiments, the second condition and associated second parameters may be preconfigured in the WTRU.

In various embodiments, the WTRU may receive configuration information indicating the second condition and associated second parameters.

In various embodiments, the WTRU may comprise circuitry including a processor, a receiver, a transmitter, and memory configured to carry out the method 2000.

### Example Method for Determining a Primary LBT Sub-Band

FIG. 21 is a diagram illustrating an example method 2100 for determining a primary LBT sub-band. The method 2100 may be implemented in a WTRU. As shown at 2110, the WTRU may determine a plurality of channel state metrics for a plurality of LBT sub-bands. As shown at 2120, the WTRU may select a LBT sub-band from the plurality of LBT sub-bands as a primary LBT sub-band for type B LBT based on a channel state metric associated with the LBT sub-band satisfying a condition. As shown at 2130, the WTRU may perform a type B LBT operation in the plurality of LBT sub-bands using the selected LBT sub-band as the primary LBT sub-band.

In various embodiments, the channel state metric associated with the LBT sub-band may comprise a channel busy ratio (CBR) of the LBT sub-band.

In various embodiments, the channel state metric associated with the LBT sub-band may satisfy the condition in a case where the CBR of the LBT sub-band is lower than a first threshold.

In various embodiments, the channel state metric associated with the LBT sub-band may satisfy the condition in a case where the CBR of the LBT sub-band is a lowest CBR among a plurality of CBRs associated with the plurality of LBT sub-bands.

In various embodiments, the channel state metric associated with the LBT sub-band may comprise a channel occupancy ratio (CR) of the WTRU for the LBT sub-band.

In various embodiments, the channel state metric associated with the LBT sub-band may satisfy the condition in a case where the CR of the WTRU for the LBT sub-band is lower than a second threshold.

In various embodiments, the channel state metric associated with the LBT sub-band may satisfy the condition in a case where the CR of the WTRU for the LBT sub-band is a lowest CR of the WTRU among a plurality of CRs associated with the plurality of LBT sub-bands.

In various embodiments, the WTRU may comprise circuitry including a processor, a receiver, a transmitter, and memory configured to carry out the method 2100.

### Example Method for Selecting a Slot in a Resource Selection Window

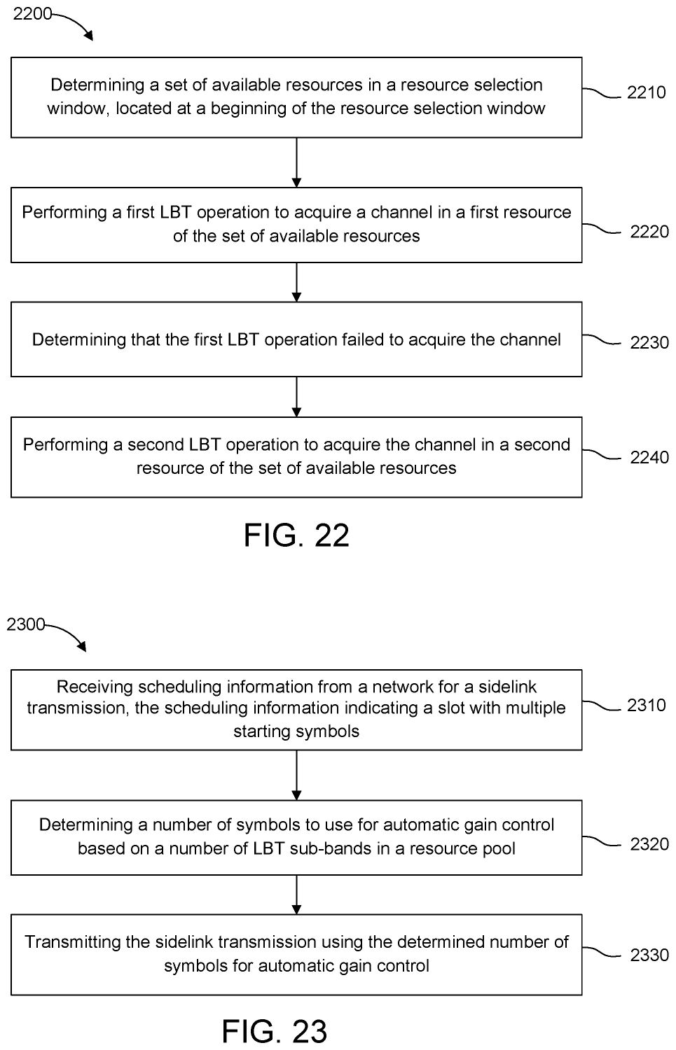

FIG. 22 is a diagram illustrating an example method 2200 for selecting a slot in a resource selection window. The method 2200 may be implemented in a WTRU. As shown at 2210, the WTRU may determine a set of available resources in a resource selection window, located at a beginning of the resource selection window. As shown at 2220, the WTRU may perform a first LBT operation to acquire a channel in a first resource of the set of available resources. As shown at 2230, the WTRU may determine that the first LBT operation failed to acquire the channel. As shown at 2240, the WTRU may perform a second LBT operation to acquire the channel in a second resource of the set of available resources.

In various embodiments, the set of available resources may be determined based on a configured number of available resources in the resource selection window.

In various embodiments, the configured number of available resources may be preconfigured in the WTRU.

In various embodiments, the WTRU may receive configuration information indicating the configured number of available resources.

In various embodiments, the first LBT operation may be for transmission of a transport block, and the configured number of available resources may be function of a QoS of the transport block.

In various embodiments, the configured number of available resources may be function of any of one or more LBT parameters and a CBR of a resource pool.

In various embodiments, the set of available resources may be determined based on a sub-window of the resource selection window. In various embodiments, the sub-window may be of a configured size.

In various embodiments, the configured size of the sub-window may be preconfigured in the WTRU.

In various embodiments, the WTRU may receive configuration information indicating the configured size of the sub-window.

In various embodiments, the first LBT operation may be for transmission of a transport block, and the configured size of the sub-window may be function of a QoS of the transport block.

In various embodiments, the configured size of the sub-window may be function of any of one or more LBT parameters and a CBR of a resource pool.

In various embodiments, the first LBT operation may be for an initial transmission of a transport block.

In various embodiments, the set of available resources may be selected from multiple LBT sub-bands.

In various embodiments, the first resource may be randomly selected from the set of available resources.

In various embodiments, the second resource may be randomly selected from next available resources of the set of available resources.

In various embodiments, the second resource may be selected as next available resource in the set of available resources.

In various embodiments, the WTRU may comprise circuitry including a processor, a receiver, a transmitter, and memory configured to carry out the method 2200.

Example Method for Transmission in a First Starting Symbol of a Slot with Multiple Starting Symbols

FIG. 23 is a diagram illustrating an example method 2300 for transmission in a first starting symbol of a slot with multiple starting symbols. The method 2300 may be implemented in a WTRU. As shown at 2310, the WTRU may receive scheduling information from a network for a sidelink transmission. In various embodiments, the scheduling information may indicate a slot with multiple starting symbols. As shown at 2320, the WTRU may determine a number of symbols to use for automatic gain control based on a number of LBT sub-bands in a resource pool. As shown at 2330, the WTRU may transmit the sidelink transmission using the determined number of symbols for automatic gain control.

In various embodiments, in a case where the number of LBT sub-bands in the resource pool is one, the number of symbols to use for automatic gain control may be one.

In various embodiments, in a case where the number of LBT sub-bands in the resource pool is more than one, the number of symbols to use for automatic gain control may be equal to the number of LBT sub-bands in the resource pool.

In various embodiments, in a case where the number of LBT sub-bands in the resource pool is more than one, the number of symbols to use for automatic gain control may be equal to two.

In various embodiments, the number of symbols may be determined further according to a bandwidth associated with the sidelink transmission.

In various embodiments, the number of symbols may be determined further according to whether the sidelink transmission spans over the resource pool.

In various embodiments, in a case where the sidelink transmission spans over the resource pool, the number of symbols to use for automatic gain control may be equal to one.

In various embodiments, in a case where the sidelink transmission is localized in a set of contiguous resources of the resource pool, the number of symbols to use for automatic gain control may be greater than one.

In various embodiments, the number of LBT sub-bands in a resource pool may be pre-configured in the WTRU.

In various embodiments, the WTRU may comprise circuitry including a processor, a receiver, a transmitter, and memory configured to carry out the method 2300.

Any characteristic, variant or embodiment described for a method is compatible with an apparatus device comprising means for processing any of the disclosed methods, with a device comprising a processor configured to process any of the disclosed methods, with a computer program product comprising program code instructions and with a non-transitory computer-readable storage medium storing program instructions.

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of infrared capable devices, i.e., infrared emitters and receivers. However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, MME, EPC, AMF, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶6 or means-plus-function claim format, and any claim without the terms “means for” is not so intended.

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Application Specific Standard Products (ASSPs); Field Programmable Gate Arrays (FPGAs) circuits, any other type of integrated circuit (IC), and/or a state machine.

The WTRU may be used in conjunction with modules, implemented in hardware and/or software including a Software Defined Radio (SDR), and other components such as a camera, a video camera module, a videophone, a speakerphone, a vibration device, a speaker, a microphone, a television transceiver, a hands free headset, a keyboard, a Bluetooth® module, a frequency modulated (FM) radio unit, a Near Field Communication (NFC) Module, a liquid crystal display (LCD) display unit, an organic light-emitting diode (OLED) display unit, a digital music player, a media player, a video game player module, an Internet browser, and/or any Wireless Local Area Network (WLAN) or Ultra Wide Band (UWB) module.

Although the various embodiments have been described in terms of communication systems, it is contemplated that the systems may be implemented in software on microprocessors/general purpose computers (not shown). In certain embodiments, one or more of the functions of the various components may be implemented in software that controls a general-purpose computer.

In addition, although the invention is illustrated and described herein with reference to specific embodiments, the invention is not intended to be limited to the details shown. Rather, various modifications may be made in the details within the scope and range of equivalents of the claims and without departing from the invention.

1.-20. (canceled)

21. A method implemented in a wireless transmit/receive unit (WTRU), the method comprising:
receiving scheduling information from a network for at least one sidelink transmission, wherein the scheduling information indicates a plurality of contiguous resource block (RB) sets;
performing listen before talk (LBT) in the plurality of contiguous RB sets; and
responsive to successful LBT in the plurality of contiguous RB sets, transmitting the at least one sidelink transmission in the plurality of contiguous RB sets, wherein the at least one sidelink transmission comprises sidelink control information indicating the plurality of contiguous RB sets used to transmit the at least one sidelink transmission.

22. The method of claim 21, wherein the plurality of contiguous RB sets comprises a plurality of contiguous LBT sub-bands.

23. The method of claim 21, wherein the scheduling information further indicates any of a frequency and a duration of resources of the plurality of contiguous RB sets.

24. The method of claim 21, wherein the scheduling information further indicates one or more parameters to be used to perform LBT in the plurality of contiguous RB sets.

25. The method of claim 24, wherein performing LBT in the plurality of contiguous RB sets comprises performing LBT according to the indicated one or more parameters.

26. The method of claim 21, wherein the at least one sidelink transmission comprises any of a physical sidelink control channel (PSCCH) transmission and a physical sidelink shared channel (PSSCH) transmission.

27. The method of claim 21, wherein the scheduling information further indicates a physical uplink control channel (PUCCH) resource to report hybrid automatic repeat request (HARQ) feedback information related to the at least one sidelink transmission.

28. The method of claim 27, further comprising transmitting the HARQ feedback information in the PUCCH resource related to the at least one sidelink transmission.

29. The method of claim 28, wherein the HARQ feedback information indicates a resource usage status associated with the at least one sidelink transmission.

30. The method of claim 28, wherein the HARQ feedback information indicates a positive acknowledgement.

31. A method implemented in a wireless transmit/receive unit (WTRU), the method comprising:
receiving scheduling information from a network for at least one sidelink transmission, wherein the scheduling information indicates (i) a plurality of contiguous resource block (RB) sets and (ii) a physical uplink control channel (PUCCH) resource to report hybrid automatic repeat request (HARQ) feedback information related with the at least one sidelink transmission;
performing listen before talk (LBT) in the plurality of contiguous RB sets; and
responsive to LBT failing in at least one RB set of the plurality of contiguous RB sets, transmitting a HARQ negative acknowledgment (NACK) in the PUCCH resource.

32. The method of claim 31, wherein the plurality of contiguous RB sets comprises a plurality of contiguous LBT sub-bands.

33. The method of claim 31, wherein the scheduling information further indicates any of a frequency and a duration of resources of the plurality of contiguous RB sets.

34. The method of claim 31, wherein the scheduling information further indicates one or more parameters to be used to perform LBT in the plurality of contiguous RB sets.

35. The method of claim 34, wherein performing LBT in the plurality of contiguous RB sets comprises performing LBT according to the indicated one or more parameters.

36. The method of claim 31, wherein the at least one sidelink transmission comprises any of a physical sidelink control channel (PSCCH) transmission and a physical sidelink shared channel (PSSCH) transmission.

37. A wireless transmit/receive unit (WTRU) comprising circuitry, including a transmitter, a receiver, a processor, and memory, configured to:
receive scheduling information from a network for at least one sidelink transmission, wherein the scheduling information indicates (i) a plurality of contiguous resource block (RB) sets and (ii) a physical uplink control channel (PUCCH) resource to report hybrid automatic repeat request (HARQ) feedback information related with the at least one sidelink transmission;
performing listen before talk (LBT) in the plurality of contiguous RB sets;
on condition that LBT succeeds in the plurality of contiguous RB sets, transmit the at least one sidelink transmission in the plurality of contiguous RB sets, wherein the at least one sidelink transmission comprises sidelink control information indicating the plurality of contiguous RB sets used to transmit the at least one sidelink transmission; and
on condition that LBT fails in at least one RB set of the plurality of contiguous RB sets, transmit a HARQ negative acknowledgment (NACK) in the PUCCH resource.

38. The WTRU of claim 37, wherein the plurality of contiguous RB sets comprises a plurality of contiguous LBT sub-bands.

39. The WTRU of claim 37, wherein the scheduling information further indicates any of a frequency and a duration of resources of the plurality of contiguous RB sets.

40. The WTRU of claim 37, wherein the scheduling information further indicates one or more parameters to be used to perform LBT in the plurality of contiguous RB sets.
